(19) United States
(12) Patent Application Publication
(10) Pub. No.: US 2003/0174685 A1
(43) Pub. Date: Sep. 18, 2003

(54) Mobile terminal device, communications device, telephone system, and communications control method

(75) Inventor: Masahiko Hasebe, Ichinomiya-shi (JP)

Correspondence Address: McDERMOTT, WILL & EMERY, 600 13th Street, N.W., Washington, DC, 20005-3096, US

(73) Assignee: Sanyo Electric Co., Ltd.

(21) Appl. No.: 10/386,650

(22) Filed: Mar. 13, 2003

(30) Foreign Application Priority Data
Mar. 15, 2002 (JP) 2002-072535 (P)

(51) Int. Cl. H04Q 7/24

(52) U.S. Cl. 370/338; 370/352; 370/349; 370/356

(57) ABSTRACT

Disclosed is a mobile phone having functions of a conventional telephone function over a public network and also communication via the Internet. An object of the present invention is to easily switch between the functions of the mobile phone, and also, to easily execute communication via the Internet. A mobile terminal device (1) has a conventional mobile phone function, and also a function as a slave unit of an Internet telephone. When being used as the slave unit of the Internet telephone, a voice signal inputted from an audio input unit (2) of the mobile terminal device (1) is encoded at a codec processing unit (5), and then a signal processing unit 7 attaches an error correction code and the like. This data is sent to a communications device (13) by a wireless processing unit. The communications device (13) converts the audio data into a packet structure appropriate for the Internet communications, and then outputs it to the Internet. Accordingly, the Internet telephone via the communications device (13) is realized.

### BACKGROUND OF THE INVENTION

1. Field of the Invention

The present invention relates to a mobile terminal device, a communications device, a telephone system, and a communications control method, and more particularly to preferable techniques for the same using an Internet telephone.

2. Description of the Related Art

In accordance with the widespread use of the Internet, telephone communications service via the Internet is starting to be provided. The communications service utilizes Voice over Internet Protocol (hereinafter, referred to as VOIP), which is a technique for sending/receiving audio data over the Internet. That is, this communications service is performed by substituting the Internet for a portion or the entirety of a public network (including both analog and digital networks) which are used in conventional telephone communication.

In the case of the communication using the Internet, the public network was used to connect to a provider. Since communication fees for using of the Internet are not determined by distances, generally the communication fee is cheaper than that using the conventional analog telephone network. Thus, the communication using the Internet is advantageous with respect to the fees especially in a case of performing long-distance communication.

At present, there are 3 types of systems for the Internet telephone.

(1) Between Personal Computers (hereinafter, referred to as PCs)

In this system, users who will communicate with each other connect to the Internet, and they provide their IP addresses to each other to enable the Internet communication. The necessary fee for the communication is the contracted usage fee for the provider and a connection fee to an access point.

(2) Between a PC and a General Telephone

In this system, the PC calls the general telephone via the Internet, but the side being called does not need to be aware that the Internet is being used. The fee necessary for the communication is the contracted usage fee for the provider, the connection fee to the access point, and the Internet communication service fee.

(3) Between General Telephones

In this system, the Internet telephone is realized via a gateway server (a server for mutually exchanging data transmitted to the Internet and to the public telephone line network) for conducting the Internet telephone service. The user calls the gateway server, and provides information for distinguishing him/her, and a telephone number and other such necessary information regarding an opposite party. Fees necessary for the communication are a connection fee to the access point and the Internet telephone service fee.

In the conventional system using the PC, the user's ID information, provider settings, and the like had to be inputted into the PC, and this made usage difficult for a person unaccustomed to the PC. Further, even the conventional system using the general telephone required complicated procedures such as calling the gateway server and providing various information and the like were necessary to start the conversation, and thus it was not easily used by everyone.

On the other hand, existing mobile phones already have telephone number books and other such functions. While using the telephone number book or other such function, if both the conventional telephone and the Internet telephone can be used easily, the above-mentioned economical advantage and also convenience could be improved. More particularly, in the future, assigning numbers similar to present telephone numbers to Internet telephones is being considered. In such a case, it is predicted that it will be necessary to build a system in which the above-mentioned telephone number book function can be effectively utilized, while the Internet telephone is easily operated.

In anticipation of the above-mentioned need, the present invention has as an object to provide an Internet telephone for pursuing both the low Internet telephone fees and the convenience of the mobile phone, which can be used easily by anyone anywhere.

### SUMMARY OF THE INVENTION

In the present invention, after a communications device connected to the Internet is placed, for example, in a home, when a mobile terminal device is used inside the home, a connection to the Internet is made via the communications device, and when the terminal device is used outside the home, a connection to a public network is made via a base station. In the case of connecting to the Internet, addressee information (a telephone number and the like) of an opposite party's terminal device is sent from the mobile terminal device to the communications device. The communications device outputs this addressee information to the Internet, and a connection is established with the opposite party's terminal device.

When the user is outside the home, the mobile terminal device cannot perform wireless communications with the communications device. In this case, when the user tries to connect to the Internet, an error notification from the terminal device, or more preferably an inquiry as to whether or not to switch to the public network connection, is outputted to the user. Receiving this notification, when the user inputs an instruction to connect to the public network, the mobile terminal device accesses the base station and establishes a connection to the opposite party's terminal device via the public network.

Further, when the communications via the public network are performed with the opposite party's terminal device, for example, the user moves from outside the home to inside the home, and when the wireless communications with the communications device become possible, the terminal device outputs to the user a notification indicating that the connection to the communications device has become possible. When the user receives this notification and inputs an instruction to connect to the Internet, the processing of connecting to the Internet is executed. For example, the mobile terminal device sends the addressee information of the opposite party's terminal device to the communications device. The communications device receives the addressee information and establishes the connection with the opposite party's terminal device. After that, the mobile terminal device severs the communications via the public network. Accordingly, the communications path via the Internet is established with the opposite party's terminal device.

Further, at a time of performing the communications via the Internet with the opposite party's terminal device, the user moves from inside the home to outside the home for example, and when the wireless communications with the communications device become difficult, the terminal device outputs to the user a notification indicating that the communications via the Internet have become difficult. When the user receives this notification and inputs an instruction to connect to the public network, processing for connecting to the public network is executed.

According to the present invention, for example, depending on whether the user is inside the home or outside the home, the communications via the Internet and the communications via the public network can be selected as necessary, so that convenience for the user can be improved. At this time, the user, without performing a special setting, merely inputs the addressee information (the telephone number and the like) of the opposite party's terminal device, to thereby make it possible to execute the communications via the Internet. At the time of moving to/from inside the home/outside the home, the communications via the Internet and the communications via the public network can be switched automatically or by a simple operation. In this way, according to the present invention, both the communications via the Internet and the communications via the public network can be performed by a simple and convenient operation.

According to a first aspect of the present invention, it can be understood that a mobile terminal device includes:

a first communications means for performing communications via a base station;

a second communications means for performing communications via a communications device connected to the Internet;

data processing means for processing an input data to generate send data and for processing receive data to generate an output data; and

setting means for setting whether to establish a data send/receive path between the first communications means and the data processing means or to establish a data send/receive path between the second communications means and the data processing means.

According to a second aspect of the present invention, it can be understood that a terminal device includes:

a first communications means for performing communications via a base station;

a second communications means for performing communications via a communications device connected to the Internet;

data processing means for processing an input data to generate send data and for processing receive data to generate an output data;

distinguishing means for distinguishing a condition of communications with the communications device; and

control means for performing control to establish a data send/receive path between the first communications means and the data processing means or to establish a data send/receive path between the second communications means and the data processing means.

In this case, in a case where the distinguishing means distinguishes that the data send/receive with the communications device is possible, the control means performs control to establish the data send/receive path between the second communications means and the data processing means, and in a case where the distinguishing means distinguishes that the data send/receive with the communications device is not possible, the control means performs control to establish the data send/receive path between the first communications means and the data processing means.

Further, in the state where the data send/receive path has been established between the first communications means and the data processing means, when the distinguishing means distinguishes that the data send/receive with the communications device is possible, the control means performs control to establish a data send/receive path between the second communications means and the data processing means.

Further, in the state where the data send/receive path has been established between the second communications means and the data processing means, when the distinguishing means distinguishes that the data send/receive with the communications device is difficult, the control means performs control to establish a data send/receive path between the first communications means and the data processing means.

According to a fifth aspect of the present invention, it can be understood that a communications device includes:

Internet communications means for performing data communications via the Internet;

terminal communications means for performing communications with the terminal device; and

data processing means for processing data received from the Internet communications means and providing the processed data to the terminal communications means, and also processing data received by the terminal communications means and providing the processed data to the Internet communications means.

According to a sixth aspect of the present invention, it can also be understood that a telephone system is constituted by:

a communications device connected to the Internet; and

a mobile terminal device capable of performing communications with the communications device.

Here, the communications device has:

Internet communications means for performing data communications via the Internet;

terminal communications means for performing communications with the terminal device; and

data processing means for processing the data received from the Internet communications means and providing the processed data to the terminal communications means, and also processing the data received by the terminal communications means and providing the processed data to the Internet communications means.

Further, the mobile terminal device includes:

a first communications means for performing communications via a base station;

a second communications means for performing communications with a communications device connected to the Internet;

data processing means for processing an input data to generate send data and for processing receive data to generate an output data; and

control means for performing control to establish data send/receive between the first communications means and the data processing means or to establish data send/receive between the second communications and the data processing means.

According to a seventh aspect of the present invention, it can be understood that a communications control method performs either the communications via the base station or the communications via the Internet.

According to one aspect of this communications control method, the method includes:

a first processing for distinguishing a condition of the communications with the communications device connected to the Internet; and

a second processing for controlling a selection of a communications mode in response to a distinction result produced by the first processing,

wherein, when an instruction to select the communications via the Internet is inputted, the first processing distinguishes the condition of the communications with the communications device connected to the Internet, and in a case where the result indicates that data send/receive with the communications device is possible, the communication via the Internet is selected, and in a case where the data send/receive with the communications device is not possible, processing for selecting the communications via the base station is executed.

According to another aspect of the communications control method, the method includes:

a first processing for distinguishing a condition of the communications with the communications device connected to the Internet; and

a second processing for controlling the selection of the communications mode in response to the distinction result produced by the first processing,

wherein, in a state where the communication via the base station has been selected, when the first processing distinguishes that data send/receive with the communications device is possible, processing for switching to the communications via the Internet is executed.

According to another aspect of the communications control method, the method includes:

a first processing for distinguishing a condition of the communications with a communications device connected to the Internet; and

a second processing for controlling a selection of a communications mode in response to the distinction result produced by the first processing,

wherein, in a state where communications via the Internet have been selected, when it is distinguished by the first processing that data send/receive with the communications device is difficult, processing for switching to communications via a base station is executed.

The present invention offers a preferable technique using telephone communications, but can also be applied beyond telephone communications to mail communications and data communications. Therefore, the data to be communicated broadly includes image data, text data, and the like, in addition to audio data.

The above-mentioned and other objects and novel characteristics of the present invention will become more completely clear when the descriptions of embodiments below are read with reference to the attached drawings. However, the embodiments below are essentially examples of the present invention, and do not limit the scope of the present invention.

### BRIEF DESCRIPTION OF THE DRAWINGS

In the accompanying drawings:

FIG. 1 shows an overall structural diagram of a telephone system according to Embodiment 1;

FIG. 2 shows a structure of a mobile phone and a home gateway, according to Embodiment 1;

FIG. 3 shows a processing flow chart of a system on a sending side according to Embodiment 1;

FIG. 4 shows a processing flow chart of a system on a receiving side according to Embodiment 1;

FIG. 5 shows a structure of a mobile phone and a home gateway, according to Embodiment 2;

FIG. 6 shows a processing flow chart of a system on a receiving side according to Embodiment 2;

FIG. 7 shows an overall structural diagram of a telephone system according to Embodiment 3;

FIG. 8 shows a structure of a mobile phone according to Embodiment 3;

FIG. 9 shows a flow chart of a communication mode setting processing according to Embodiment 3;

FIGS. 10A and 10B show diagrams of examples of structures of a telephone number book according to Embodiment 3;

FIG. 11 shows a diagram of an example of a structure of another telephone number book according to Embodiment 3;

FIG. 12 shows a flowchart of another communication mode setting processing according to Embodiment 3;

FIG. 13 shows a flow chart of processing at a time of displaying whether another Internet mode is usable/unusable according to Embodiment 3;

FIG. 14 shows a flow chart of yet another communication mode setting processing according to Embodiment 3;

FIG. 15 shows an overall structural diagram of a telephone system according to Embodiment 4;

FIG. 16 shows a processing sequence at a time of switching a telephone mode according to Embodiment 4;

FIG. 17 shows a flow chart of processing at the time of switching the telephone mode according to Embodiment 4;

FIG. 18 shows another processing sequence at the time of switching the telephone mode according to Embodiment 4;

FIG. 19 shows a flow chart of another processing at the time of switching the telephone mode according to Embodiment 4; and

FIG. 20 shows a diagram illustrating an example of a structure of a priority sequence table according to Embodiment 4.

### DETAILED DESCRIPTION OF THE PREFERRED EMBODIMENTS

Hereinafter, description is made of embodiments of the present invention, with reference to the drawings.

### Embodiment 1

Hereinafter, description is made of Embodiment 1 of the present invention, with reference to the drawings.

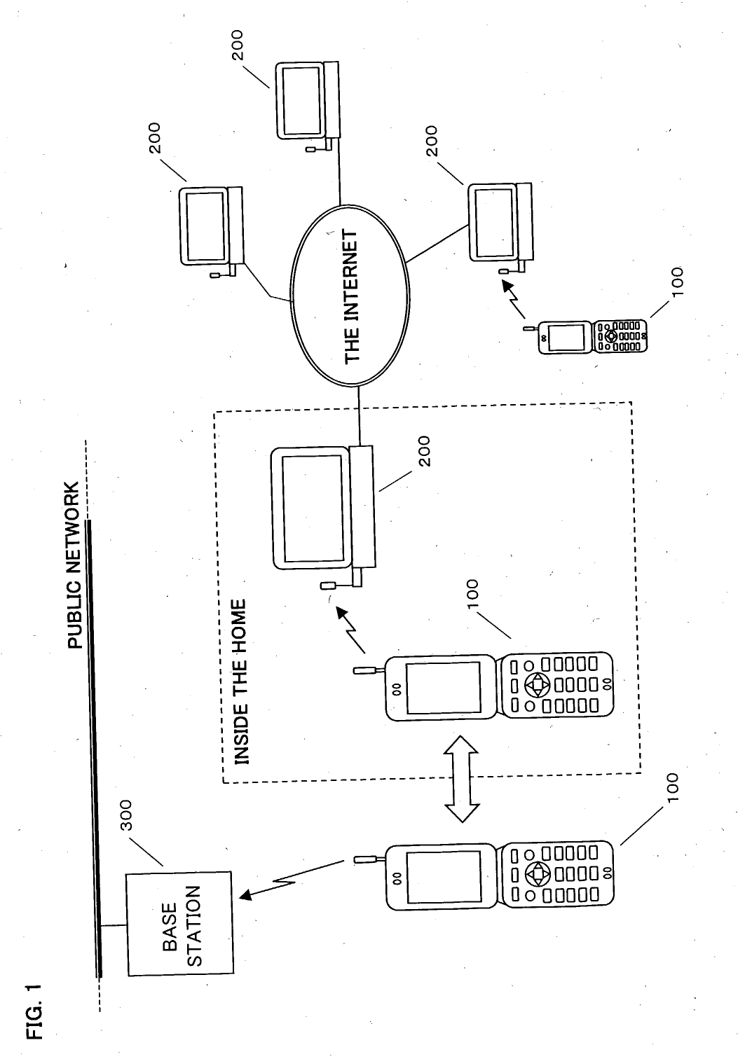

FIG. 1 is a diagram showing a configuration of a telephone system according to Embodiment 1 of the present invention. Note that, according to this embodiment, an audio codec type in a conventional mobile phone communication, and that in a Internet telephone communication, are the same.

This present system is composed of a mobile phone 100 and a home gateway 200. Further, the mobile phone 100 is wirelessly connectable to the home gateway 200. Further, by connecting to a base station 300, communication is available via a public network (including both of analog and digital systems). Further, the home gateway 200 is connectable to the Internet. The mobile phone 100 connects to the home gateway 200 to enable communication via the Internet.

In a case where a user conducts the communication from inside the home, the user can select either the communication via the Internet, or the communication via the public network. Further, when the wireless communications with the home gateway 200 is not possible, for example in a case where the mobile phone 100 has been taken outside the home, only the communication via the public network is available.

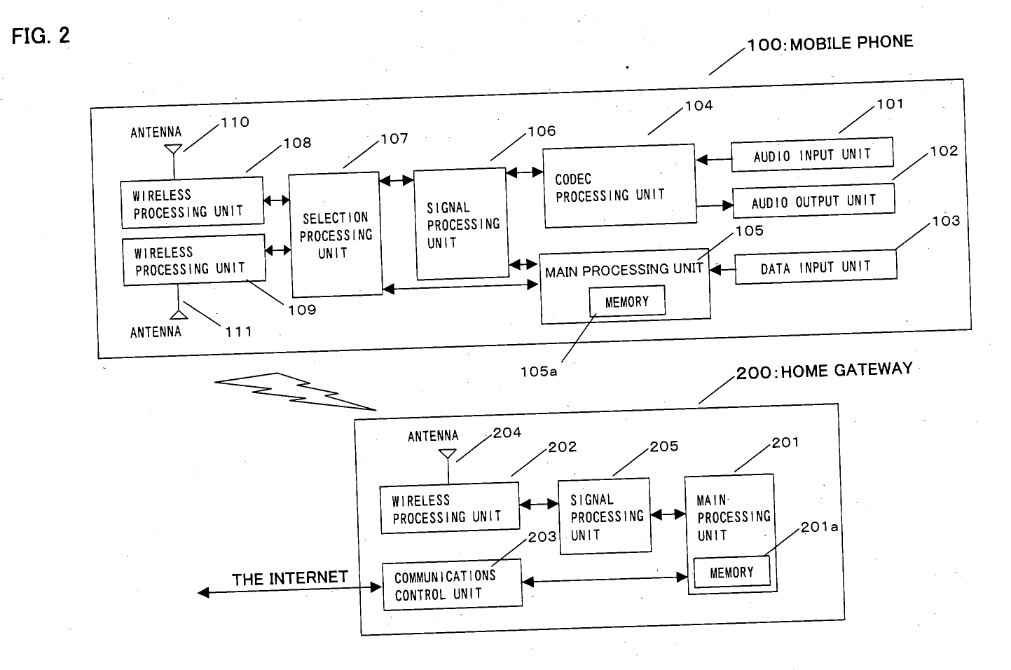

Next, description is made regarding the configuration of the mobile phone 100 and the home gateway 200, which constitute the above-mentioned telephone system, with reference to FIG. 2.

First, description is given regarding the configuration of the mobile phone 100.

The mobile phone 100 is constituted by an audio input unit 101, an audio output unit 102, a data input unit 103, a codec processing unit 104, a main processing unit 105, a signal processing unit 106, a selection processing unit 107, wireless processing units 108 and 109, and antennas 110 and 111.

After voice from the speaker (the user) is inputted into the audio input unit 101, the audio input unit 101 processes the received voice, and audio data is outputted. The audio output unit 102 processes the audio data and outputs audio to the speaker. The data input unit 103 has a key operating unit, which is used, for example, when setting a switch between usage inside the home and that outside the home, and when inputting destination telephone number. The codec processing unit 104 performs an A/D conversion, a D/A conversion, and encoding/decoding processing on the audio data. The main processing unit 105 performs control of each processing unit. Further, it also has a memory 105a inside it.

Inside the memory 105a, there are stored a wireless ID assigned to the home gateway, a wireless ID assigned to the user's own mobile phone (mobile phone 100), a telephone number assigned to the mobile phone 100, and a telephone number book for managing the telephone number assigned to the user's own mobile phone and opposite destination telephone numbers.

The signal processing unit 106 performs signal processing such as an error correction processing and the like. The selection processing unit 107, in response to the control by the main processing unit 105, selects either one of the wireless processing units 108 and 109, and sends/receives a signal to/from the selected wireless. processing unit. The wireless processing units 108 and 109 perform a D/A conversion, an A/D conversion, and a modulation/demodulation according to the communications format used. The antennas 110 and 111 send/receive a signal via radio waves.

Note that, the wireless processing unit 108 and the antenna 110 are communication means used in the case where the mobile phone 100 is used outside the home (i.e., the conventional communication by the mobile phone), and they send/receive the signal to/from the base station. Further, the wireless processing unit 109 and the antenna 111 are communications means used in the case where the mobile phone 100 is used inside the home (i.e., the communication by the Internet telephone) and send/receive the signal to/from the home gateway 200.

Next, the configuration of the home gateway 200 is explained. The home gateway 200 gives the above-mentioned mobile phone 100 the Internet telephone function. The home gateway 200 is arranged, for example, inside the home of the user who owns the above-mentioned mobile phone 100. Therefore, when the user is inside the home, via the home gateway 200, the user can receive an Internet telephone service with his or her own mobile phone 100.

The home gateway 200 is constituted by a main processing unit 201, a wireless processing unit 202, a communications control unit 203, an antenna 204, and a signal processing unit 205.

The main processing unit 201 performs control of each processing unit and also has a memory 201a built inside it. In the memory 201a there are stored an IP address of the home gateway 200 (whatsoever specifies the opposite party, such as a mail address is valid), a wireless ID assigned to itself, and a wireless ID assigned to the wireless communications destination.

The wireless processing unit 202 performs a D/A conversion, an A/D conversion and a modulation/demodulation processing according to the communications format used. The communications control unit 203 performs communications processing of connecting to the Internet. The antenna 204 sends/receives a signal via radio waves. The signal processing unit 205 performs signal processing such as error correction processing on the send/receive data.

Next, description is made regarding application form of the above-mentioned mobile terminal device, and operations at that time.

<Communication Outside the Home>

Description is made regarding the case where the mobile phone 100 is used outside the home. In the case where the mobile phone 100 is used outside the home, the wireless communications are not performed to the home gateway 200, and the communication using the Internet telephone via the home gateway 200 is not performed. Therefore, in this case, the communications using the conventional mobile phone mode is performed. In other words, the communication (the communications) using the public network via the base station 300 is performed.

First, in the case of sending the audio, a mode for usage outside the home is set from the data input unit 103 by switching between an outside-the-home and inside-the-home usage. Then, from the data input unit 103, the destination telephone number (any format specifying the opposite party may be used, for example the conventional telephone number, the IP address or the mail address) is inputted, and the user waits for establishment of a call connection (a- state in which the communications path for communication is established) with the telephone of the opposite party.

The input of the telephone number may be performed through direct input using the key operating unit arranged to the data input unit 103, and also performed by selecting the telephone number of a opposite party from the telephone number book stored in the memory 105a.

The call connection with the opposite party via the base station is established, and after that, when the user speaks to the audio input unit 101, the voice signal is A/D converted by the codec processing unit 104, and after that, it is encoded according to a predetermined audio codec type. As the codec type, any codec type, which is used in PDC, PHS, CdmaOne, W-CDMA, Cdma2000, GSM, IMT2000 and other such communications method, or G.711, G.729, G729A, G723.1, G.726, G.722.1, AMR-WB and the like, can be used, but the codec type is not limited to these, and other formats maybe used. Further, the audio may be sent in the unencoded form as it is.

The signal processing unit 106 attaches header information and an error correction code to the audio data processed by the codec processing unit 104 according to the communications method used in the communication, converts the audio data into audio data which is appropriate for communications, and outputs it to the selection processing unit 107.

The selection processing unit 107 outputs to the wireless processing unit 108 the communications audio data which was sent from the signal processing unit 106, according to an instruction from the main processing unit 105. The wireless processing unit 108 performs the modulation processing and the like according to the communications method to be used, and after that, it outputs the communications audio data via the antenna 110 as radio waves. This audio is sent via the base station 300 to the opposite party.

Next, description is made regarding a case in which the mobile phone 100 receives a communications audio data from the opposite party.

The communications audio data is received by the antenna 110. The communications audio data received by the antenna 110 is demodulated at the wireless processing unit 108 according to the communications method to be used. At the selection processing unit 107, the communications audio data sent from the wireless processing unit 108 is outputted just as it is, to the signal processing unit 106 in response to an instruction of the main processing unit 105.

The signal processing unit 106 uses the error correction code to extract from the communications audio data only the audio portion having no error, and treats this portion as the audio data, and outputs it to the codec processing unit 104. The codec processing unit 104 performs decoding on the audio data according to the predetermined audio codec type, and the decoded data undergoes the D/A conversion, and is outputted from the audio output unit 102 as the audio. At this time, if the audio data has not been encoded, the decoding is not performed at the codec processing unit 104.

The above-mentioned audio sending/receiving processing enables the communication outside the home to be performed.

Communication Inside the Home

(1) A case of establishing the call connection from the user's own mobile terminal device to the opposite party

Description is made regarding a case of using the mobile phone 100 inside the home. In this case, the wireless communications between the mobile phone 100 and the home gateway 200 are available. Therefore, while sending/receiving the audio data to/from the home gateway 200, the communication can be performed via the Internet. Of course, as in the above-mentioned “Communication outside the home”, the communication in the conventional mobile phone mode via the base station 300 is also available. Hereinafter, description is made regarding the case of performing the Internet telephone communication via the home gateway 200.

First, in the case of sending the audio (voice) to the opposite party, the mode for usage inside the home is set from the data input unit 103 of the mobile phone 100, by means of the input for switching between outside-the-home and inside-the-home usage. Then, when the telephone number (whatever specifies the opposite party's home gateway, the IP address or the mail address format or the like may also be used in addition to the telephone number, but as an example, the telephone number is used here) of the opposite party's home gateway corresponding to the opposite party's phone is inputted from the data input unit 103, the telephone number is sent to the home gateway 200 by means of a processing mentioned below.

First, the telephone number inputted from the data input unit 103 is sent via the main processing unit 105 to the signal processing unit 106. Depending on the communications method (for example, Bluetooth, IEEE802.11a, IEEE802.11b, IEEE802.11e, IEEE802.11g, IrDA or any other type with the standard of wireless communications) used in the wireless communications with the home gateway 200, the signal processing unit 106 adds the header information and the error correction code and the like, to the telephone number, a wireless ID specifying the destination device of the wireless communications read out from the memory 105a via the main processing unit 105, and the like, and converts them into an appropriate communications telephone number data, and outputs these to the selection processing unit 107.

The selection processing unit 107 outputs, to the wireless processing unit 109, the communications telephone number data sent from the signal processing unit 106, according to the instruction from the main processing unit 105. The wireless processing unit 109 performs the modulation processing and the like according to the communications method to be used, and after that, sends the communications telephone number data over radio waves via the antenna 111.

The communications telephone number data is received by the wireless processing unit 202 via the antenna 204 of the home gateway 200. The wireless processing unit 202 performs demodulation processing on the received communications telephone number data according to the communications method to be used, and outputs this to the signal processing unit 205. The signal processing unit 205 uses the error correction code and extracts from the communications telephone number data the telephone number and the wireless ID with no error, and outputs these to main processing unit 201.

The main processing unit 201 compares the provided wireless ID and its own wireless ID stored in the memory 201a, and in a case where both are the same, a call control explained below is executed. On the other hand, in a case where both are not the same, a response data for notifying this fact is provided to the signal processing unit 205, and a response is sent via the wireless processing unit 202 to the mobile phone 100.

In the call control, the main processing unit 201 incorporates the opposite party's telephone number provided from the mobile phone 100, its own IP address stored in the memory 201a, and a server IP address and the like described below, into call control data, and sends this to a communications control unit 203.

Here, the call control refers to control for establishing a communications path with the opposite party over the Internet (for example, a server 1, which terminal A is connected to, searches for a server 2, which terminal B is connected to and establishes communications path instead of terminal A, and sends the call control data received from terminal A to terminal B via the server 2). In addition it refers to control for searching for the opposite party's location (Before the above-mentioned control, inquiring of the server which manages the correspondence between the user's telephone number and user ID and the like, and the opposite party's address, for example, the IP address, and specifying the opposite party's address, for example the IP address corresponding to the opposite party's telephone number, the user ID and the like), and determining the audio codec type to be used in the communication, and the like. These controls are executed using a protocol such as SIP, H.323, MGCP, or MEGACO.

The main processing unit 201 adds a UDP or TCP header, an IP header and the like to the call control data, and performs the call connection to the opposite party through the communications control unit 203, for example, an RJ45 modular interface connected to the Internet.

When the call connection with the opposite party is established, the user starts speaking into the audio input unit 101 at the mobile phone 100. Subsequently, the processing up to the codec processing unit 104 and the signal processing unit 106 is the same as the audio sending processing outside the home. Therefore, the details are omitted here.

The communications audio data outputted from the signal processing unit 106 is inputted into the selection processing unit 107, and according to the instruction from the main processing unit 105, the selection processing unit 107 outputs the communications audio data to the wireless processing unit 109. The wireless processing unit 109 sends the communications audio data to the home gateway 200.

The antenna 204 of the home gateway 200 receives the communications audio data, and sends it to the wireless processing unit 202. Hereinafter, the processing performed on the received communications audio data up to the wireless processing unit 202 and the signal processing unit 205 is the same as the processing at the time of sending the above-mentioned telephone number. That is, the audio data processed by the signal processing unit 205 is inputted into the main processing unit 201, and is converted into a data structure for sending/receiving the communications audio data over the Internet (for example, the RTP header, the UDP or TCP header, the IP header and other codes are attached). The converted data is outputted to the Internet via the communications control unit 203 to the opposite party.

Note that, the sending of the audio data after establishing the communications path is performed via the home gateway 200 as described above, but the receiving of the audio data from the opposite party is also performed via the home gateway 200. That is, the main processing unit 201 of the home gateway 200 processes the opposite party's audio data received via the communications control unit 203 to remove the RTP header, the UDP or TCP header, the IP header and the like, and then outputs this to the signal processing unit 205. The signal processing unit 205 attaches the header information and the error correction code and the like to convert it into the appropriate communications audio data, depending on the communications method used in the wireless communications with the mobile phone 100 (for example, Bluetooth, IEEE802.11a, IEEE802.11b, IEEE802.11e, IEEE802.11g, IrDA or any other method with wireless communications standard may be used) and outputs it to the wireless processing unit 202.

The wireless processing unit 202 performs the modulation processing, according to the communications method to be used, and after that, via the antenna 204, sends the opposite party's communications audio data to the mobile phone 100 over radio waves. The data is received by the wireless processing unit 109 via the antenna 111 of the mobile phone 100, and thereafter, the same processing as the audio reception processing during the outside-the-home usage is performed on the opposite party's communications audio data. Accordingly, the opposite party's communication data is outputted from the audio output unit 102.

(2) A case of establishing the call connection from the opposite party to the user's own mobile terminal device

Description is made regarding a case of establishing the call connection from the opposite party to the user's own mobile phone 100, via the Internet.

As described above, the opposite party's home gateway obtains the IP address of the home gateway 200 from the above-mentioned server by means of a call control similar to the one mentioned above, and the IP address is used to establish the call connection with the home gateway 200.

After that, at the main processing unit 201 of the home gateway 200, the opposite party's audio data received via the communications control unit 203 undergoes the processing opposite from that performed at the sending pricess, whereby the RTP header, the UDP or TCP header, the IP header and the like are removed, and then it is outputted to the signal processing unit 205. The signal processing unit 205 attaches the header information and the error correction code and the like onto the opposite party's audio data and the wireless ID which specifies the destination device of the wireless communications opposite party and is read out from the memory 105a via the main processing unit 105, converts them into the appropriate communications audio data, according to the communication format (for example, Bluetooth, IEEE802.11a, IEEE802.11b, IEEE802.11e, IEEE802.11g, IrDA and any other format with wireless communications standard may be used) used in the wireless communications with the mobile phone 100, and outputs it to the wireless processing unit 202.

The wireless processing unit 202 performs the modulation processing and the like according to the communications method to be used, and after that, sends out the communications audio data over radio waves via the antenna 204. This data is received by the wireless processing unit 109 via the antenna 111 of the mobile phone 100.

The wireless processing unit 109 performs the demodulation processing on the received communications audio data, according to the communications method to be used, and outputs it to the selection processing unit 107. The selection processing unit 107 provides this to the signal processing unit 106. The signal processing unit 106 extracts the wireless ID from the communications audio data, and provides this to the main processing unit 105. The main processing unit 105 compares the provided wireless ID and the wireless ID stored in the memory 105a, and in the case where both are the same, it instructs the signal processing unit 106 to perform processing of the communications audio data. The signal processing unit 106 receives this and performs the error correction on the received communications audio data, and provides this to the codec processing unit 104. Thereafter, the same processing as the audio receipt processing outside the home is performed, and the audio data is converted into the audio signal and outputted from the audio output unit 102.

Note that, in the above case, in the case where the main processing unit 105 distinguished that the provided wireless ID and the wireless ID stored in its own memory 105a are not the same, the main processing unit 105 provides the response data for notifying of this fact to the signal processing unit 106, and causes a response transmission to the home gateway 200, via the wireless processing unit 109. When the home gateway 200 receives this response data, it emits a notification response indicating that communications with the user's own mobile phone 100 is impossible to the opposite party's home gateway, via the communications control unit 203.

Similarly, communications with the user's own mobile phone 100 becomes impossible as in the case where the user's own mobile phone 100 is taken outside the home, the home gateway 200 sends the notification response indicating that the communications with the user's own mobile phone 100 are impossible to the opposite party's home gateway 200, via the communications control unit 203. In this case, the main processing unit 201 distinguishes whether or not the communications with the user's own mobile phone 100 are possible, depending on the presence/absence of the response from the user's own mobile phone 100. In other words, after performing the wireless communication via the above-mentioned wireless processing unit 202, in the case where there is no response from the user's own mobile phone 100 during a given duration of time, it is distinguished that the communications with the user's own mobile phone 100 are impossible.

Note that, the receiving of the audio data after the communications path is established is performed via the home gateway 200, as described above, but the sending of the audio data to the opposite party's phone is also performed via the home gateway 200. The processing of the audio data at the time of sending is similar to the processing explained at the above-mentioned (1). Therefore, description is omitted here.

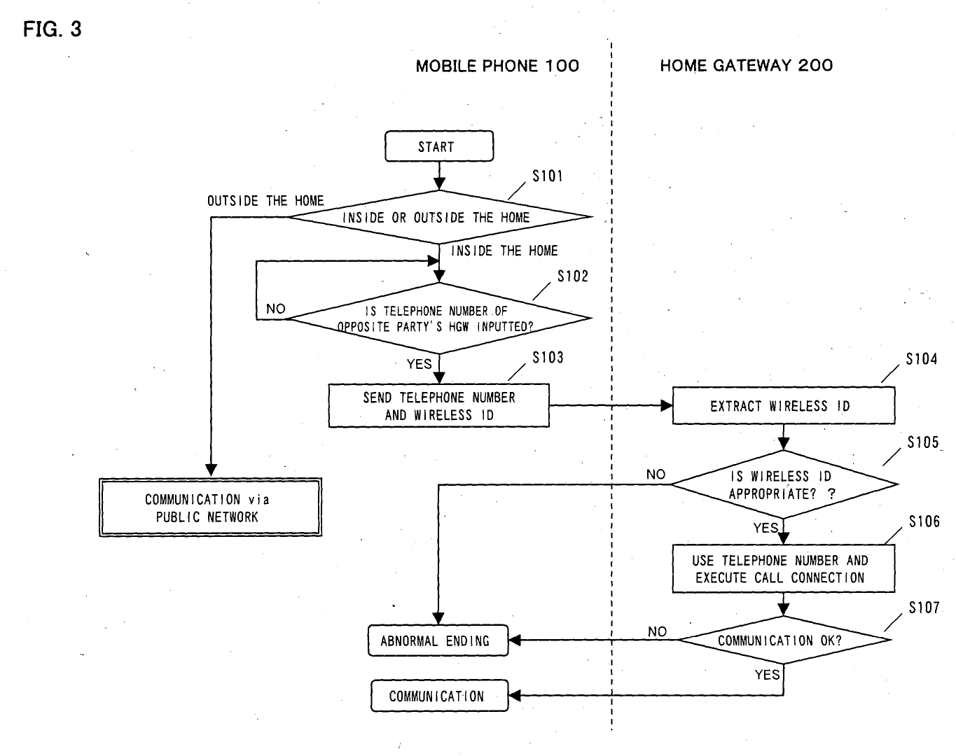

FIG. 3 is a flow chart of the processing on the sending side with respect to “(1) the case of establishing the call connection from the user's own mobile terminal device to the opposite party”, among the above-mentioned processing.

The user operates the data input unit 103 of the mobile phone 100 to set to the inside-the-home communication mode (S101), and when the telephone number of the opposite party's home gateway is inputted (S102), the mobile phone 100 reads the wireless ID of the user's home gateway 200 out from the memory 105a, and sends the wireless ID and the telephone number to the home gateway 200 (S103).

The home gateway 200 extracts the wireless ID from the receive data (S104), and compares this wireless ID to the wireless ID stored in the memory 201a, and determines whether or not the received wireless ID is appropriate (S105). Then, if the wireless ID is appropriate, the call control is executed (S106). Then, when the communications with the opposite party's home gateway becomes possible (S107), the communication with the opposite party's phone is started.

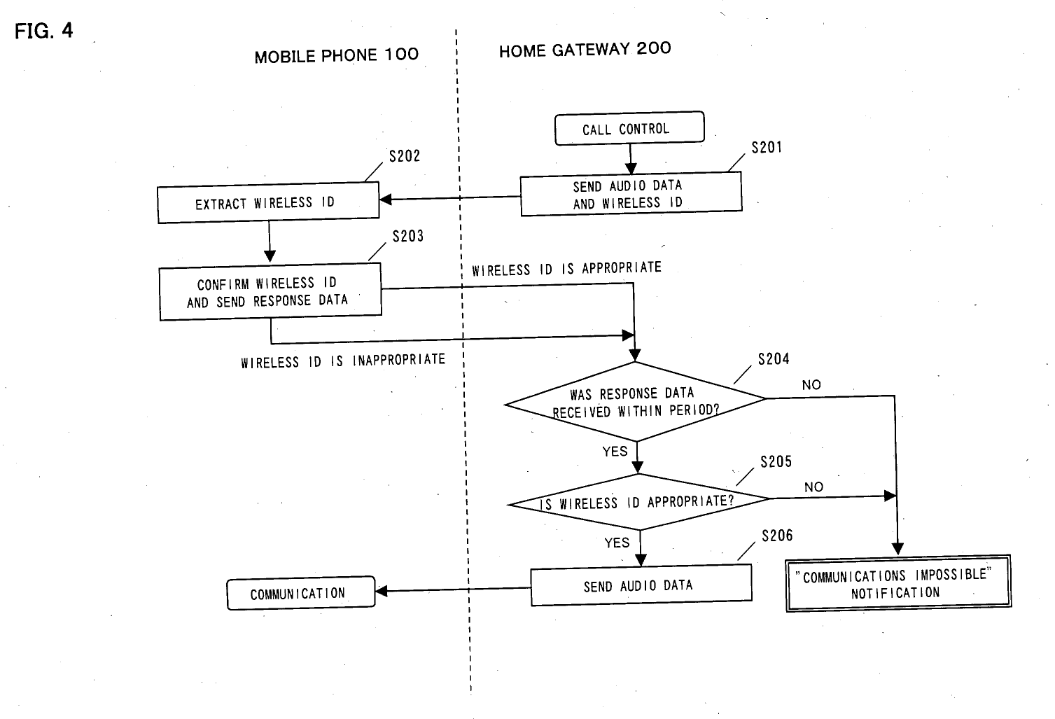

FIG. 4 is a flow chart of processing on the receiving side in “(2) the case of establishing the call connection from the opposite party to the user's own mobile terminal device”, among the above-mentioned operations.

When the call control with the opposite party's home gateway is completed, the home gateway 200 reads out the wireless ID of the user's mobile phone 100 from the memory 201a, and sends the receive audio data and the wireless ID to the mobile phone 100 (S201).

The mobile phone 100 extracts the wireless ID from the receive data (S202), and compares this wireless ID and the wireless ID stored in the memory 105a, and determines whether or not the received wireless ID is appropriate. Then, a response data according to the determination result is sent to the home gateway 200 (S203).

On the home gateway 200 side, it is determined whether or not the response data is received from the mobile phone 100 within the given duration of time (S204), and in the case where the response data is not received within the given duration of time, a notification indicating that the communication is impossible is sent to the opposite party's home gateway. Further, also in the case where the received response data indicates that the wireless ID is not appropriate (S205), the notification indicating that the communication is impossible is sent to the opposite party's home gateway.

If the wireless ID is appropriate, the audio data from the opposite party's home gateway is sent in sequence to the mobile phone (S206). Accordingly, the communication processing with the opposite party's phone is started.

### Embodiment 2

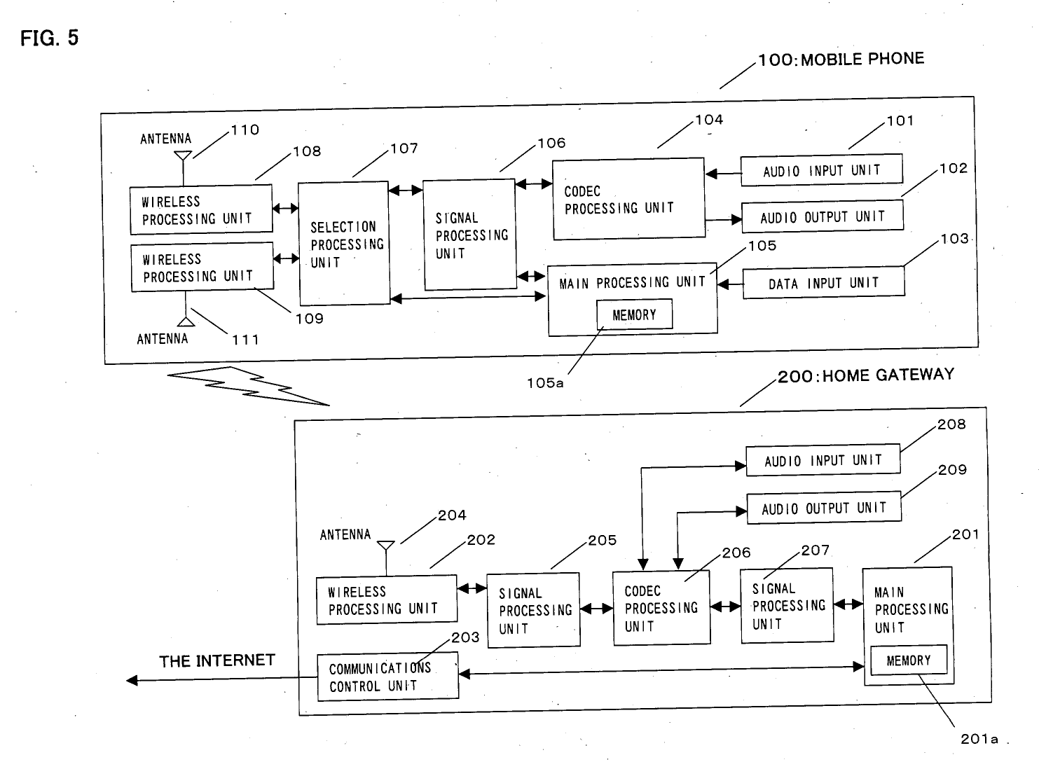

FIG. 5 is a main portion block diagram showing a configuration of a telephone system, showing Embodiment 2 of the present invention. This embodiment shows a case where the audio codec type during the conventional mobile phone communication and the audio codec type during the Internet telephone communication are different.

The mobile phone 100 is constituted by the audio input unit 101, the audio output unit 102, the data input unit 103, the codec processing unit 104, the main processing unit 105, the signal processing unit 106, the selection processing unit 107, the wireless processing unit 108, the wireless processing unit 109, the antenna 110 and the antenna 111.

Further, the home gateway 200 is constituted by the main processing unit 201, the wireless processing unit 202, a communications control unit 203, the antenna 204, the signal processing unit 205, the codec processing unit 206 and the signal processing unit 207.

The structural difference from Embodiment 1 described above is that the home gateway 200 has the codec processing unit 206, the signal processing unit 207, the audio input unit 208 and the audio output unit 209. In accordance with Embodiment 2, in the case where the wireless communications with the user's own mobile phone 100 cannot be performed, the communication is performed via the audio input unit 208 and the audio output unit 209 of the home gateway 200.

Hereinafter, Embodiment 2 is explained centered on the points of difference from Embodiment 1 of the present invention.

The processing in the case where the mobile phone 100 is used outside the home (the case where the communication is performed according to the conventional mobile phone mode), is the same as in Embodiment 1, but in the case of usage inside the home (the case where the communication is performed in the Internet telephone mode), the processing is different from the above-mentioned embodiment. Hereinafter, description is made regarding the case of sending from inside the home via the Internet.

In this case, similarly to Embodiment 1 described above, the send/receive of the audio data is performed between the mobile phone 100 and the home gateway 200, as the communication is performed via the Internet. First, the mode for usage inside the home is set from the data input unit 103 by switching between outside-the-home and inside-the-home usage.

Then, after inputting the opposite party's telephone number from the data input unit 103, the user waits for the completion of the call connection (the state in which the communications path for the communication is established) to the opposite party's telephone via the communications control unit 203. The processing up to this point is the same as in Embodiment 1 (explained with respect to the case in which the audio is sent from inside the home), and no special processing is performed at the codec processing unit 206 and the signal processing unit 207.

After the call connection is established, when the user speaks into the audio input unit 101, the codec processing unit 104 performs on the voice signal processing other than encode decode processing, for example the A/D conversion, and after that, the signal processing unit 106 attaches the header information and the error correction code and the like to covert it into appropriate communications audio data, and outputs it to the selection processing unit 107.

In this way, in the case of communicating via the home gateway 200, the codec processing unit 104 performs the A/D conversion but not the encode processing. This is because this embodiment is different from the Embodiment 1 above in that the codec type in the conventional mobile phone communication and the codec type in the Internet telephone communication are different. The codec processing corresponding to the Internet telephone is performed by the codec processing unit 206 of the home gateway 200, as described below.

Subsequent to the codec processing unit 104, the processing up to the signal processing unit 205 is the same processing as when sending the telephone number according to Embodiment 1. Thus, the signal processing unit 205 provides the communications audio data received from the user's own mobile phone 100 to the codec processing unit 206. After that, at the codec processing unit 206, the communications audio data is encoded according to a predetermined audio codec type as that used in the mobile phone 100 described in the Embodiment 1. Of course, the data may be provided in the unencoded form just as it is.

The signal processing unit 207 attaches the header information and the error correction code to the audio data processed by the codec processing unit 206, to convert it into the appropriate audio data, and this is outputted to the main processing unit 201.

The main processing unit 201 converts the audio data to a data structure (for example, attaching the RTP header, the UDP or TCP header, the IP header and the like) for sending/receiving it over the Internet. This audio data is outputted to the Internet via the communications control unit 203, and then it is sent to the opposite party.

Next, description is made regarding a case where a call connection request is received from the opposite party.

Similarly to Embodiment 1 described above, the opposite party's home gateway obtains an IP address of the home gateway 200 from the above-mentioned server by means of the call control, and this IP address is used to establish the call connection with the home gateway 200.

After that, in order to determine whether or not the wireless communications are possible with the user's own mobile phone 100, the main processing unit 201 of the home gateway 200 reads out the wireless ID from the memory 201a, and generates connection request data which includes this. Then, the main processing unit 201 outputs the connection request data via the signal processing unit 207, the codec processing unit 206, the signal processing unit 205 and the wireless processing unit 202, over radio waves from the antenna 204.

The mobile phone 100 having received the data processes it in its wireless processing unit 109 and its signal processing unit 106, and extracts the wireless ID from the data and sends this to the main processing unit 105. The main processing unit 105 determines whether or not the wireless ID is the same as its own wireless ID stored in the memory 105a. Then, in the case where they are the same, the response data indicating that connection is possible is generated, and in the case where they are not the same, the response data indicating that connection is impossible is generated. The response data is processed by the signal processing unit 106, the selection processing unit 107 and the wireless processing unit 109, and after that, it is outputted over radio waves from the antenna 111.

The response data is received by the antenna 204 of a home gateway, and after that it is provided to the main processing unit 201 via the signal processing unit 205, the codec processing unit 206 and the signal processing unit 207. The main processing unit 201 analyzes the response data, and in the case where it indicates that the connection is possible, the audio data from the communications control unit 203 is provided to the mobile phone 100.

In other words, the data received via the communications control unit 203 undergoes the processing opposite from the processing at the time of sending the data, so that the RTP header, the UDP or TCP header and the IP header and the like are removed, and the data is outputted to the signal processing unit 207. The signal processing unit 207 uses the error correction code to extract from the communications audio data only the audio portion which has no error, and treats this portion as the audio data, and outputs it to the codec processing unit 206. The codec processing unit 206 performs decode processing according to a decoding type depending on the predetermined audio codec type, and then outputs this to the signal processing unit 205.

After that, the processing up to the signal processing unit 106 in the mobile phone 100 is the same receive processing as that in Embodiment 1. After that, at the codec processing unit 104, processing other than the encode/decode processing, for example, only the D/A conversion, is performed, and the audio is outputted from the audio output unit 102. Further, the voice inputted from the audio input unit 101 of the mobile phone 100 passes through the path and processing opposite from the above-mentioned receive processing, and the processed audio data is outputted from the communications control unit 203 of the home gateway 200 to the opposite party's home gateway via the Internet. Accordingly, the mobile phone 100 can be used to perform the Internet telephone communication.

In the case where the above-mentioned response data from the mobile phone 100 indicates that the connection is not possible, or in a case where the response data is not returned from the user's own mobile phone 100 within a given duration of time, the main processing unit 201 provides the audio data from the communications control unit 203 to its own audio output unit 209.

In other words, by performing the processing opposite from the time of sending on the data received through the communications control unit 203, the RTP header, the UDP or TCP header, the IP header and the like are removed, and this is outputted to the signal processing unit 207. The signal processing unit 207 uses the error correction code to extract from the communications audio data only the audio portion with no error and treats this as the audio data, and outputs it to the codec processing unit 206. The codec processing unit 206 performs the decode processing according to the given audio codec type, and then, outputs this to the audio output unit 209. Accordingly, the user can listen to the audio spoken by the opposite party.

Further, the voice signal, which the user has inputted into the audio input unit 208, undergoes the A/D conversion and the encode processing by the codec processing unit 206, and after that it is provided to the signal processing unit 207. The signal processing unit 207 performs attaching the error correction code and the like to the audio data, and then, sends this to the main processing unit 201. The main processing unit 201 sends this to the communications control unit 203. Thus, the user's audio data is sent to the opposite party's telephone via the Internet.

In this way, in accordance with Embodiment 2, the present invention can also be applied to the case where the audio data codec type of the conventional mobile phone communication and the Internet telephone communication are different, and additionally in the case where the wireless communications with the user's own mobile phone 100 are impossible, the communication with the opposite party becomes available with the home gateway 200. Thus, convenience can be improved even more than in Embodiment 1 described above.

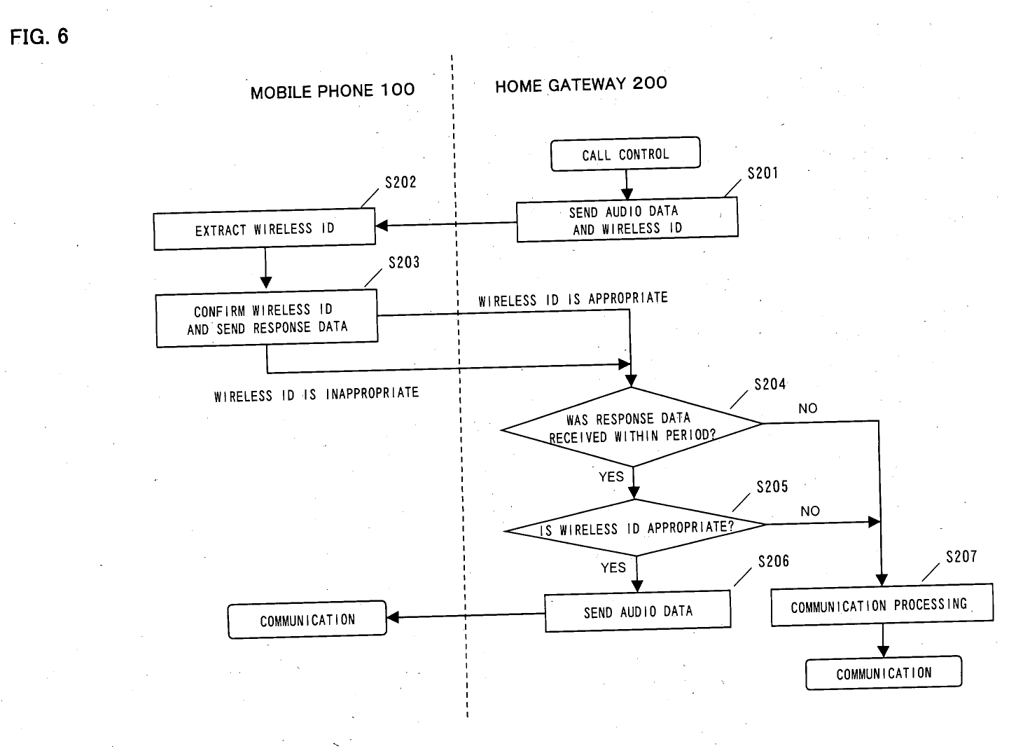

Related to Embodiment 2, FIG. 6 is a flow chart of processing in a system on the receiving side in the case where the call connection to the user's own mobile phone is established from the opposite party. Note that, the flow chart of the processing in the system on the receiving side in the case where the call connection to the opposite party is made from the user's own mobile terminal device is similar to the processing flow shown in FIG. 3 in accordance with Embodiment 1 described above.

When the call connection with the home gateway on the opposite party's side is established, the home gateway 200 reads out from memory 201a the wireless ID of the user's own mobile phone 100, and sends the received audio data and this wireless ID to the mobile phone 100 (S201).

The mobile phone 100 extracts the wireless ID from the receive data (S202), and compares this wireless ID to the wireless ID stored in the memory 105a, and determines whether or not the received wireless ID is appropriate. Then, a response data according to the result of the determination is sent to the home gateway 200 (S203).

On the home gateway 200 side, it is determined whether or not the response data is received from the mobile phone 100 within the given duration of time (S204), and in the case where the response data is not received within the given duration of time, the home gateway 200 executes a communications processing by means of its own codec processing unit 206 (S207). Accordingly, the communication processing using the gateway's own audio input unit 208 and audio output unit 209 is started. Similarly, also in the case where the received response data indicates that the wireless ID is inappropriate (S205), the communication processing by means of its own codec processing unit 206 is executed (S207).

If the wireless ID is appropriate, the audio data from the opposite party's home gateway is sequentially transferred to the mobile phone (S206). Accordingly, the communication with the opposite party's phone is started.

As described above, according to the above two embodiments, the mobile phone 100 is provided with the conventional mobile phone communication function over the public network, and the local wireless communications function to communicate with the home gateway 200, and depending on whether or not the wireless communications with the home gateway 200 are possible, the communications method is switched, whereby the mobile phone 100 is used as the conventional mobile phone outside the home and can be used as the Internet telephone inside the home, for example. Accordingly, with the same operation as with the mobile phone, anyone can easily use the Internet telephone, and in addition, if there is one home gateway 200 inside the home, the individually owned mobile phones 100 can each be used as an Internet telephone terminal.

### Embodiment 3

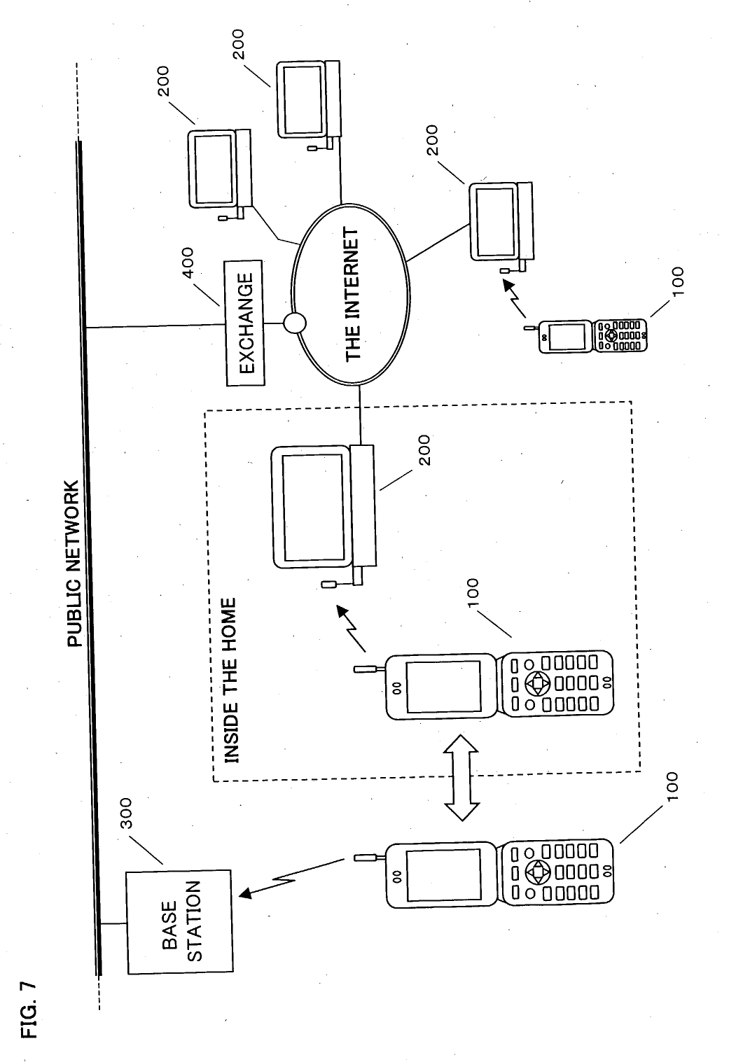

FIG. 7 shows a configuration of a telephone system according to Embodiment 3. According to the system shown in the diagram, an exchange 400, which includes the protocol conversion function, media conversion function, data transfer function and so on, is connected to both the Internet and the public network.

When the call connection is made by the Internet telephone, the exchange 400 references the opposite party's telephone number included in the call control data, and distinguishes whether this telephone number is the telephone number used by the Internet telephone, or the telephone number used by the public network. That is, if the initial numbers of the telephone number are “050”, it is distinguished as the telephone number for the Internet telephone, and in any other case it is distinguished as the telephone number for the public network. In the case of the telephone number for the public network, a communication path from the exchange 400 via the public network is established, and in the case of the telephone number for the Internet telephone, a communication path from the exchange 400 via the Internet is established.

Therefore, in the case of using the mobile phone 100 inside the home, the user can perform the conventional mobile phone communication via the base station 300 (hereinafter, referred to as the “public network mode”) and the communication via the home gateway 200 using the telephone number for the Internet telephone and for the mobile phone(hereinafter, referred to as the “Internet mode”.

In the communication using the Internet mode utilizing the telephone number for the mobile phone, an audio data from the mobile phone 100 is outputted to the Internet via the home gateway 200. Then, the exchange 400 converts the audio data into analog or digital audio data appropriate for the communication on the public network, and after that, the converted audio data is sent via the public network to the opposite party's phone. Further, the audio data from the opposite party's phone is sent via the public network to the exchange 400. Then, the audio data is converted into the audio data appropriate for the Internet telephone, and after that it is sent via the Internet to the home gateway 200. Accordingly, the communication via the Internet and public network using the Internet mode is realized.

Note that, the modulation/demodulation processing and the processing of sending/receiving the audio data, which are performed by the mobile phone 100 and the home gateway 200, are performed similarly to the above-mentioned Embodiment 1 and Embodiment 2.

Further, also in the case of connecting from the mobile phone 100 to the public network via the base station 300 in the public network mode, the communication using the Internet can be used. That is, when the telephone number is sent from the mobile phone 100 to the base station 300, this telephone number is obtained by the exchange 400 via the public network. The exchange 400 references the obtained telephone number, and if this telephone number is used for the Internet telephone, the call control with the opposite party's phone is executed via the Internet. Accordingly, the communication via the Internet and the public network becomes available in the public network mode.

That is, in the communication in the public network mode using the Internet telephone number, the audio data is outputted to the public network from the mobile phone 100 via the base station 300. Then, the exchange 400 converts the audio data into the audio data appropriate for the Internet telephone, and after that the converted data is sent via the Internet to the opposite party's phone. Further, the audio data from the opposite party's phone is sent via the Internet to the exchange 400. Then, after being converted into the digital or the analog audio data appropriate for the public network mode, it is sent via the public network to the mobile phone 100. Accordingly, the communication mentioned above is realized.

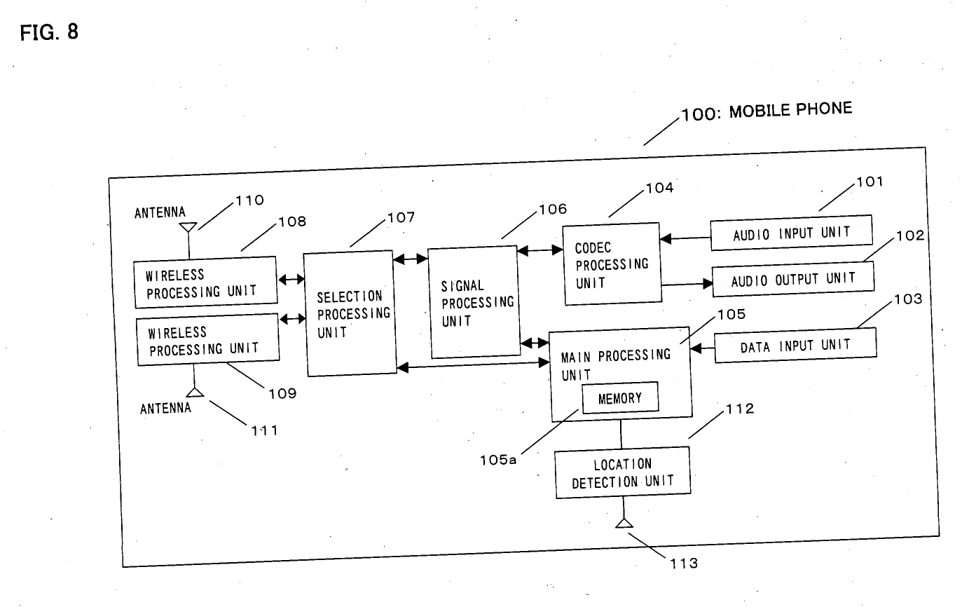

FIG. 8 shows a configuration of the mobile phone 100 according to this embodiment. In the mobile phone 100 shown in the diagram, a location detection unit 112 and an antenna 113 are added, as compared to the mobile phone adopted in the embodiments described above.

The antenna 113 receives the data over radio waves from a GPS (Global Positioning System) satellite. The location detection unit 112 uses the received data over radio waves to detect the location of the mobile phone 100, and sends the result of detection to the main processing unit 105.

Based on the detection result from the location detection unit 112, the main processing unit 105 distinguishes whether or not the communication by the Internet mode is available. Specifically, the main processing unit 105 compares a home position set in advance with a key operation by the user and the present location of the mobile phone 100, to distinguish whether or not the distance between the two is equal to or below a threshold value indicating that the communications with the home gateway 200 are possible. Then, if the distance is equal to or below the threshold value, the main processing unit 105 distinguishes that the communication by the Internet mode is available, and if the distance exceeds the threshold value, the main processing unit 105 distinguishes that the communication by the Internet mode is unavailable.

In the case where the Internet mode is available, the main processing unit 105 performs control to perform the communication by the Internet mode. Further, in the case where the Internet mode is not available, it performs the communication in the public network mode. The control at the time of the communication in the Internet mode and the control at the time of the communication in the public network mode are similar to the above-mentioned Embodiment 1 and Embodiment 2.

Note that, in the case where the Internet mode is available, the communication processing in the Internet mode does not have to start immediately, but rather an inquiry may be made to the user regarding whether the user selects the communication by the Internet mode or the communication by the public network mode. The inquiry at this time can employ a method for displaying on a monitor (omitted from the diagram in FIG. 8) on the mobile phone 100, a method for outputting an inquiry with audio from the telephone receiver, and the like.

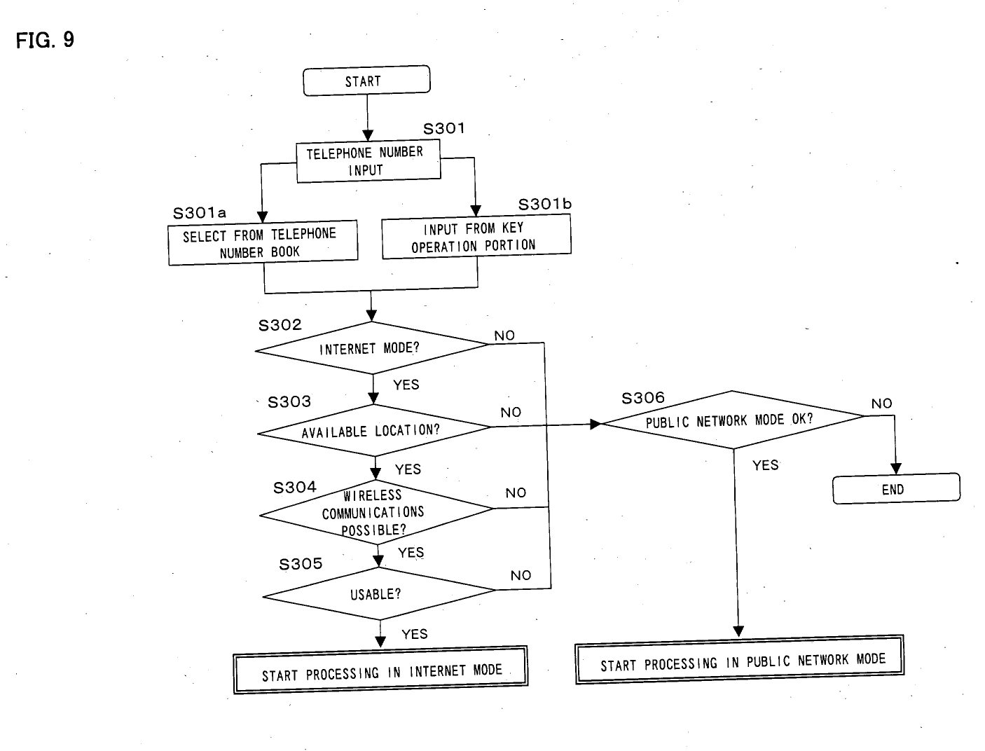

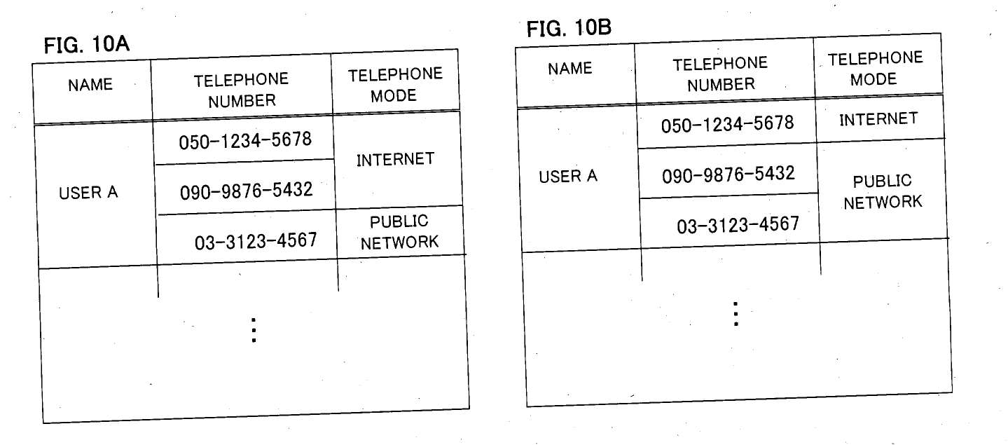

FIG. 9 shows a flow chart of a telephone mode setting processing, according to this embodiment. Note that, according to this embodiment, telephone number book information such as shown in FIGS. 10A and 10B is stored in the memory 105a of the main processing unit 105. Specifically, a user name, the user's telephone number and a telephone mode are linked and stored. Here, the telephone mode can be changed as needed by operating the key operation unit.

Referring to FIG. 9, before starting the communication, when the user inputs the telephone number (S301, S301a, S301b), the main processing unit 105 references the telephone number book stored in the memory 105a and distinguishes the telephone mode (S302) of the telephone number that was inputted. Here, if the telephone mode is the Internet mode, the main processing unit 105 then references the detection result from the location detection unit 112, and distinguishes whether or not the mobile phone 100 is at a location where the Internet mode is available (S303). If it is available, the main processing unit 105 distinguishes whether or not the wireless communications with the home gateway 200 are possible (S304), and if the wireless communications are possible, it distinguishes whether or not the home gateway 200 is usable for the Internet mode (S305).

Here, the processing at S304 is performed by sending the opposite party's telephone number and the wireless ID from the mobile phone 100 to the home gateway 200, similarly to the above-mentioned Embodiments 1 and 2. In other words, the home gateway 200 compares the received wireless ID and its own wireless ID stored in the memory 105a, and if both are the same, it sends a “wireless communications possible” response to the mobile phone 100, and if they are not the same, it sends a “wireless communications impossible” response to the mobile phone 100. The main processing unit 105 of the mobile phone 100 references this response, and distinguishes whether or not the wireless communications are possible. Further, in a case where there is no response within a given time duration after the opposite party's telephone number and the wireless ID are sent to the home gateway 200, it is distinguished that the wireless communications are impossible.

Further, at the above-mentioned S305, in a case where the number of lines which can be used as the Internet mode is determined in advance, depending on whether or not all the lines are in use, it is distinguished whether or not the Internet mode can be used. For example, in a case where the line that can be used is only one line, if that line is being used for the communication on the home gateway 200 as shown in the above-mentioned Embodiment 2, it is distinguished that the usage of the mobile phone 100 for the Internet mode is impossible.

In the above-mentioned S305, when it is distinguished that the usage as the Internet mode is possible, the call control by the home gateway 200 is executed. Then, when the call connection is established, the communication using the Internet mode is started. Note that, the call control processing are similar to the above-mentioned Embodiments 1 and 2. Further, in the case where the opposite party's telephone number is the telephone number for using the public network, the communication is started after the exchange 400 establishes the communication path via the public network, as described above.

In any of the above-mentioned S302 through S305, when the result is “NO”, an inquiry is made to the user regarding whether the telephone mode may be switched to the public network mode. The inquiry made at this time can employ the method for displaying on the monitor (omitted from the drawing in FIG. 8) of the mobile phone 100, and the method of outputting the inquiry with audio from the telephone receiver, and the like.

In response to this inquiry, when the user switches it to the public network mode, the communication processing using the public network mode is started. In other words, the telephone number inputted at S301 is outputted via the base station 300 to the public network. Then, if this telephone number is the telephone number for the public network, the communication processing using the public network is executed. Further, if this telephone number is the telephone number for the Internet telephone, the communication path via the Internet is established at the exchange 400. Accordingly, the communication using the public network and the Internet is realized.

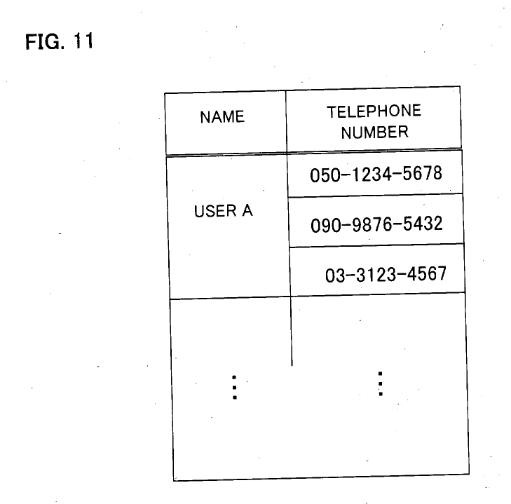

In the above-mentioned Embodiment 3, the telephone number book stored in the memory 105a can also be configured as shown in FIG. 11. In this case, the setting of the telephone mode is performed by the user separately inputting it with the key operation.

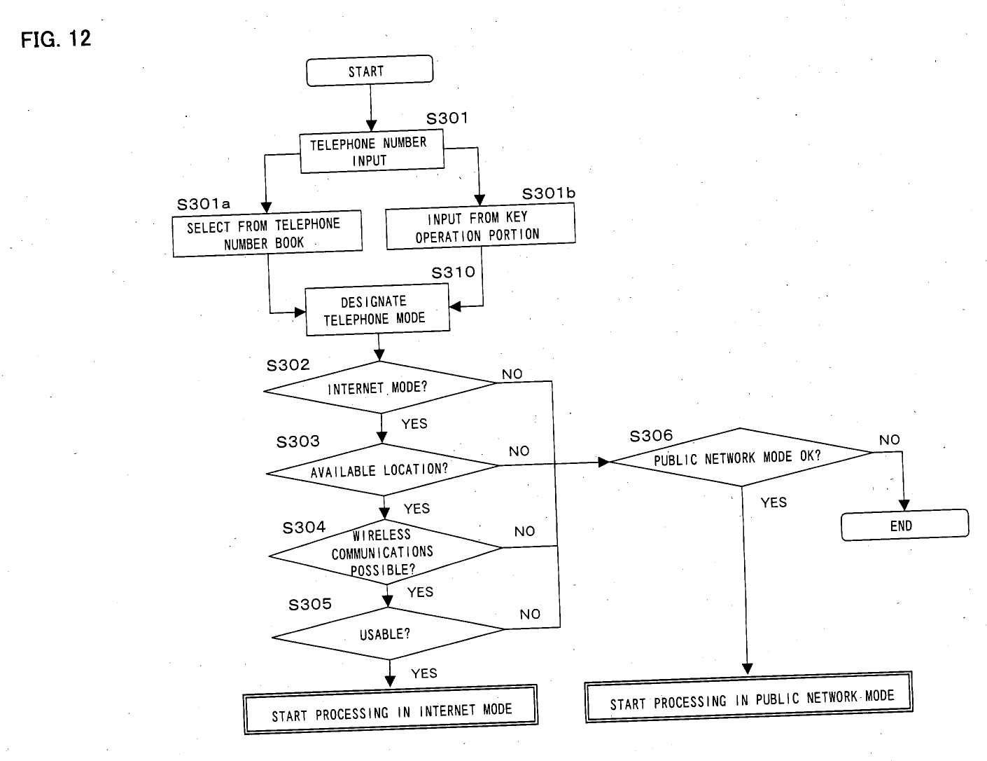

FIG. 12 shows a flow chart of processing in this case. In the flow chart in the diagram, S310 is added as compared to FIG. 9. At S310, the user selects either the communication using the public network mode or the communication using the Internet mode. Then, the telephone mode corresponding to the user's selection is set. The other processing is similar to the processing in the above-mentioned FIG. 9.

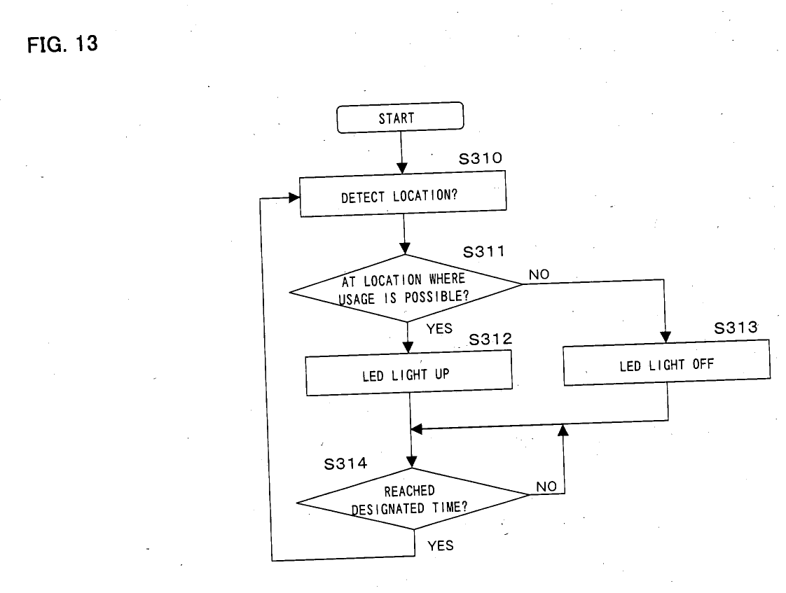

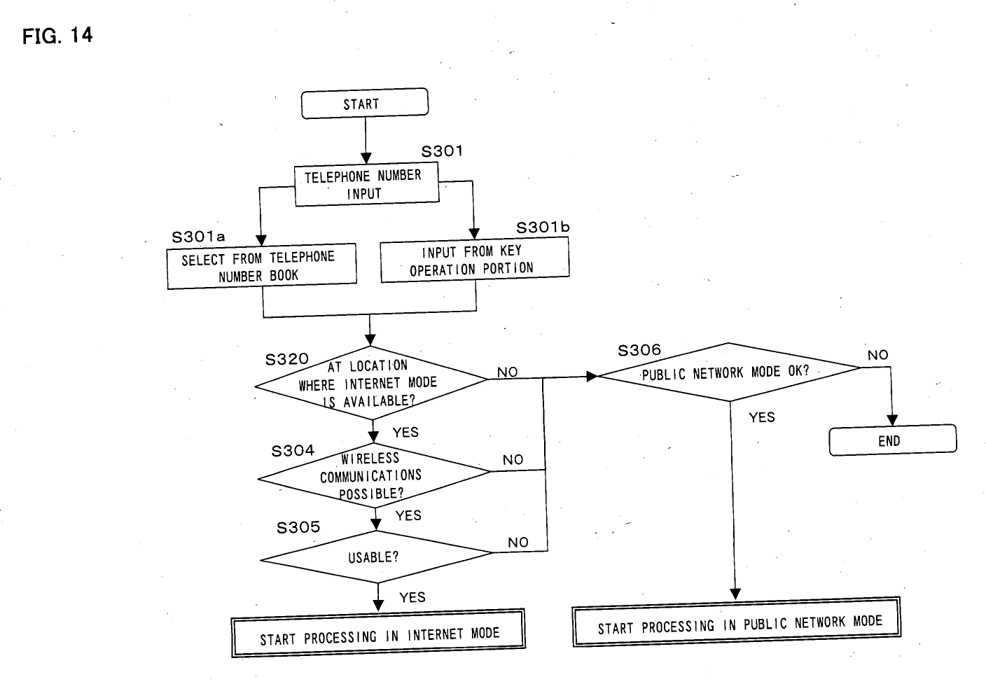

Further, in the above-mentioned embodiment, after the Internet mode has been set, it is distinguished whether or not the communication using the Internet mode is available. However, whether or not communication using the Internet mode is available can also be distinguished in advance. FIGS. 13 and 14 show flow charts of the processing in this case.

FIG. 13 is a flow chart of processing for distinguishing in advance whether or not the Internet mode is available.

The location detected by the location detection unit 112 (S310) is compared with the home location which is set in advance, and it is distinguished whether or not the distance between the two positions is equal to or less than the threshold value indicating that the communications are possible with the home gateway 200 (S311). Then, if the distance is equal to or below the threshold value, an LED (omitted from the drawing in FIG. 8) arranged in the mobile phone 100 lights up (S312), and in a case where the value exceeds the threshold, the LED turns off (S313).

The above-mentioned processing at S310 through S313 is executed at given intervals (S314). That is, every given interval, it is distinguished whether or not the present location of the mobile phone 100 is within the communications-capable distance from the home gateway 200. Then, in response to the result of distinction, the LED is turned on or turned off. The user sees the state of the LED, whereby he/she can know whether or not the communication using the Internet mode is available. Accordingly, for example at S310 in the flowchart shown in FIG. 12, the user can designate the telephone mode which he/she deems most suitable.

Note that, according to the processing flow chart in FIG. 13, in the case where the availability of the communication using the Internet mode is distinguished in advance, the processing flow chart for the communication mode setting can be modified as shown in FIG. 14. In FIG. 14, S302 and S303 are omitted as compared to the flow chart in FIG. 9, and S320 is added instead. Further, according to the flow chart in FIG. 14, the telephone number book shown in FIG. 11 is used.

In other words, in the state where the communication by the Internet mode is distinguished as possible in advance (S320), when the telephone number is inputted (S301, S310a, S301b), the procedure immediately goes to the processing at S304, regardless of whether the telephone number is the telephone number for the Internet mode or the telephone number for the public network mode. Then, similarly to the example as described above, and after the availability of the wireless communications (S304) and the availability of using the line (S305) are distinguished, the Internet mode processing is started.

Note that, at S301a in the processing steps in FIG. 14, the telephone number book is displayed on the monitor (omitted from the diagram in FIG. 8) of the mobile phone 100. However, in the state where it is distinguished that the Internet mode is available, the telephone numbers for Internet telephone among the displayed telephone numbers may be displayed in highlight. Accordingly, the user can select and input an appropriate telephone number.

Note that, even in the case where it is distinguished that the Internet mode is available, of course the user can select the telephone mode as needed.

As described above, in accordance with Embodiment 3, in response to whether or not the mobile phone 100 can communication with the home gateway 200, either the telephone mode via the base station, or the telephone mode via the home gateway is, automatically selected. Therefore, it is not necessary to force the user to switch/set the telephone mode according to whether he/she is inside the home or outside the home, whereby user convenience is further improved.

### Embodiment 4

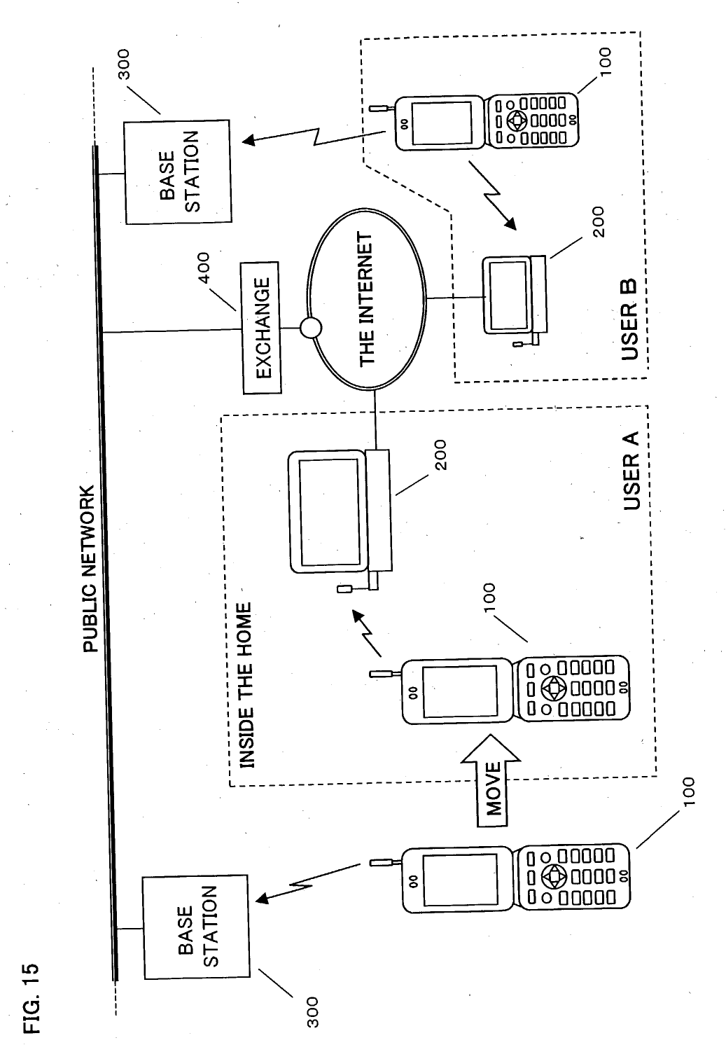

FIG. 15 shows a configuration of a telephone system according to Embodiment 4. In the system shown in FIG. 15, for example when the user moves from outside the home to inside the home and the wireless communications between the mobile phone 100 and the home gateway 200 become possible, the system automatically switches from the communication using the public network mode to the communication using the Internet mode.

For example, in the state where a user A and a user B are both performing the communication using the public network mode via the base station 300, when the user A moves from outside the home to inside the home, the call connection between the user A's home gateway 200 and the home gateway 200 of the user B is established via the Inter net. Then, when the communication path via the public network is severed, the communication by the communication path via the Internet is started.

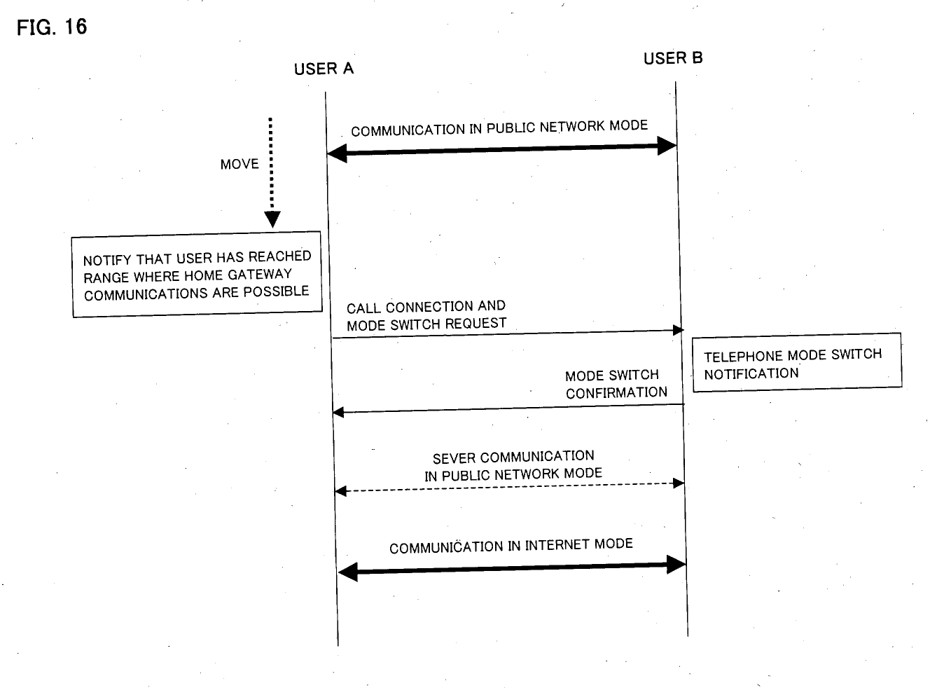

FIG. 16 shows a sequence upon transitioning from the communication using the public network mode to the communication using the Internet mode.

For example, in the state where the user A and the user B are performing the communication using the public network mode, when the user A moves from outside the home to inside the home, and when the communications between the mobile phone 100 of the user A and the home gateway 200 become possible, a notification (a message audio, beep sound, etc.) indicating that the communication using the Internet mode has become available is outputted from the mobile phone 100 of the user A. The user receives this notification, and when the user inputs an instruction to switch over to the Internet mode, the home gateway 200 of the user A performs the call control to the home gateway 200 of the user B, and also sends a request for the mode switch.

The home gateway 200 of the user B receives this request and sends a notification for the mode switch to the mobile phone 100 of the user B. Accordingly, a notification (a message audio, beep sound, etc.) indicating that the switching over to the Internet mode is outputted from the user B's mobile phone 100. Simultaneously, the home gateway 200 of the user B sends a notification for the confirmation of the mode switching to the home gateway 200 of the user A. Note that, this confirmation notification may be sent in response to the user B inputting an acknowledgement for the mode change into the mobile phone 100 of the user B.

The home gateway 200 of the user A sends to the mobile phone 100 of the user A a notification indicating that it has received the confirmation notification. The mobile phone 100 of the user A receives this notification and severs the communication path using the public network mode. Then, the communication processing using the home gateway 200 is started.

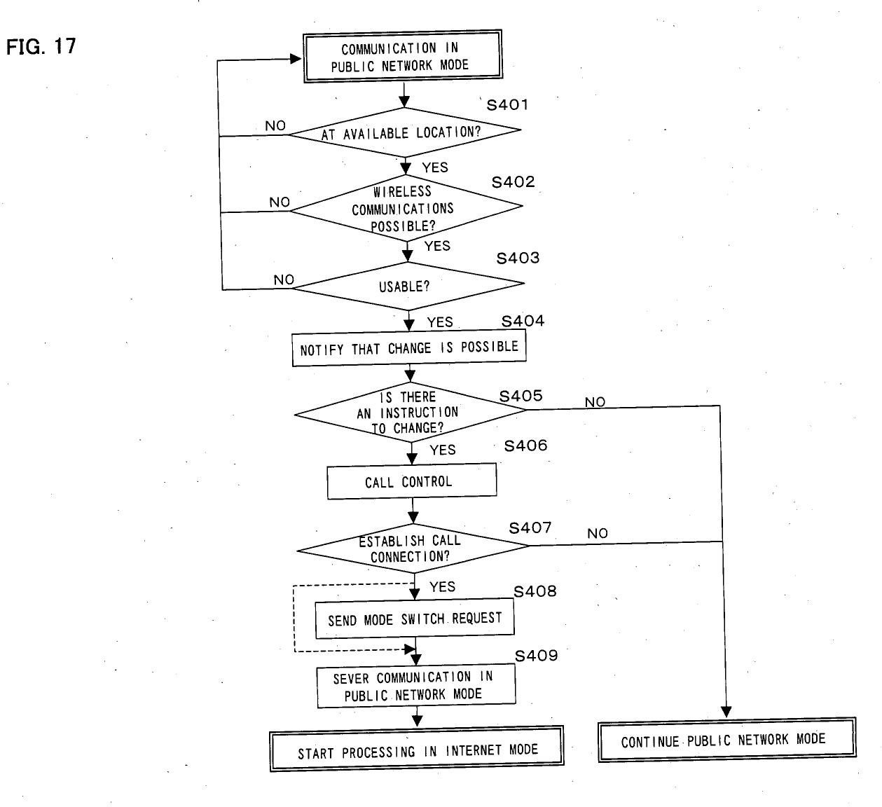

FIG. 17 shows a processing flow upon switching from the communication using the public network mode to the communication using the Internet mode.

In a state for performing the communication in the public network mode via the base station 300, the main processing unit 105 of the mobile phone 100 references the detection signal from the location detection unit 112, and distinguishes whether or not the mobile phone 100 has entered the range in which the Internet mode is usable (S401). Then, when it distinguishes that the mobile phone 100 has entered the range in which the Internet mode is usable, the main processing unit 105 distinguishes whether or not the wireless communications with the home gateway 200 inside the home are possible (S402), and it further distinguishes whether or not the line for using the Internet mode is usable (S403). Note that, the distinction processing at S401 through S403 is performed similarly to the above-mentioned S303 through S305 in FIG. 9.

In this way, when it is distinguished that the communication using the Internet mode is available, the main processing unit 105 then sends the notification message that the communication using the Internet mode has become available to the audio output unit 102, for example. This message is heard by the user via the audio output unit 102 (S404). Hearing the message, the user inputs an instruction to change to the Internet mode (S405), and the main processing unit 105 obtains from the telephone number book in the memory 105a the telephone number of the opposite party that the user is currently communicating with, and sends this with the wireless ID to the home gateway 200. Accordingly, the home gateway 200 executes the call control with the opposite party's phone (the opposite party's mobile phone 100 or home gateway 200) (S406).

Here, for the opposite party's telephone number sent to the home gateway 200, if the telephone number corresponding to the Internet telephone is registered in the telephone number book, then this one is used, and if the telephone number corresponding to the Internet telephone is not registered, then the telephone number (for example, the telephone number of the opposite party's mobile phone) corresponding to the public network is used. Further, in a case where neither telephone number exists in the telephone number book, the telephone number that is used for the current communication is used.

Note that, which telephone number to use may be selected by the user as needed.

In the above-mentioned call control processing at S406, in the case where the opposite party's telephone number is the telephone number of the home gateway 200, the processing is executed similarly to the above-mentioned Embodiments 1 and 2. Further, in the case where the opposite party's telephone number is the telephone number for the mobile phone using the public network, the telephone number sent from the home gateway 200 to the Internet is received by the exchange 400 and the communication path with the opposite party's mobile phone 100 via exchange 400 is established.

However, in the case where the opposite party's telephone number is the telephone number of the home gateway 200, the call connection is established between the user's own home gateway 200 and the opposite party's home gateway 200 (S407). Then, the mode switch request is sent from the home gateway 200 to the opposite party's home gateway 200 (S408). The opposite party's home gateway 200 receives this and sends the mode switch confirmation. And then, the user's own home gateway 200 receives this confirmation and sends to the user's own mobile phone 100, a request to sever the connection over the public network. Receiving the request, the mobile phone 100 severs the currently established communication using the public network (S409), and the system switches to the communication processing via the home gateway 200. Accordingly, the communication using the Internet mode is started.

Further, in the case where the opposite party's telephone number is the telephone number of the mobile phone using the public network, the call connection between the user's own home gateway 200 and the opposite party's mobile phone 100 is established (S407). Note that, in a case when a new call control data is received from another telephone to the opposite party's mobile phone 100 during the communication, the above-mentioned call connection is established only in a case where a function for simultaneously reserving for the call connection from the other telephone has been set in the opposite party's mobile phone 100. In a case where the opposite party's mobile phone 100 is not provided with this function, the call connection is not established at S407. When the opposite party's mobile phone 100 is provided with this function and the call connection is established, a notification (for example, a beep sound) indicating that the call connection from the other telephone has been reserved, is outputted. This beep sound is received, and when the opposite party user severs the current communication, the communication using the public network mode is severed also on the user's mobile phone 100 side (S409). In response to the severance of the communication, the main processing unit 105 in the user's own mobile phone 100 switches to the communication processing via the home gateway 200, and thus, the communication using the Internet mode is started.

Note that, as is understood from the above description, the processing at S408 is skipped in the case where the opposite party's telephone number is the telephone number of the mobile phone using the public network.

As described above, in accordance with this embodiment, when the usage of the Internet mode becomes available during the communication, the telephone mode is automatically switched from the public network mode to the Internet mode, thus further improving the user convenience.

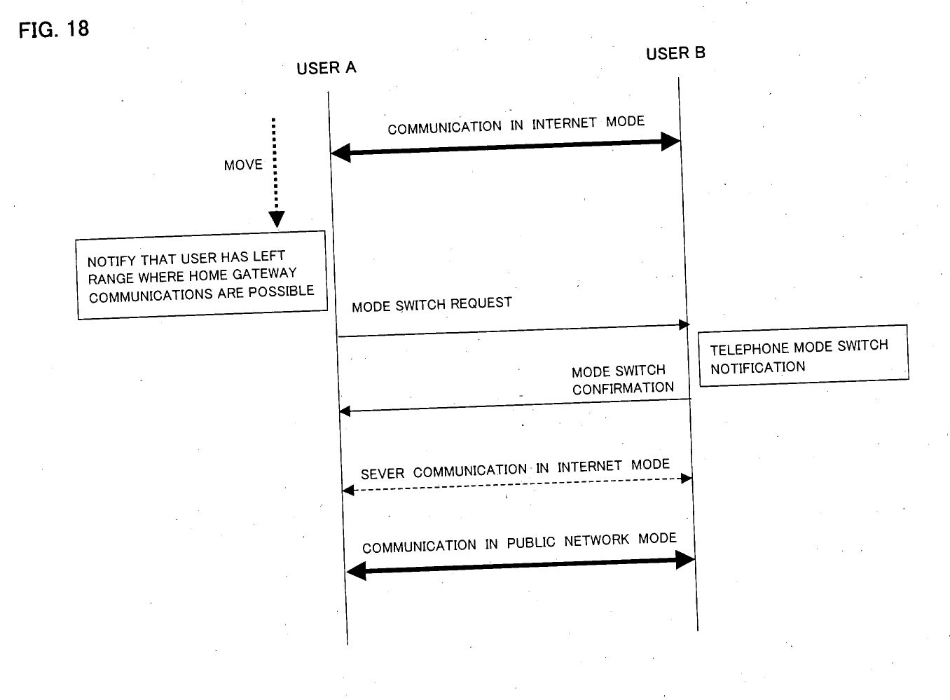

Further, in the above-mentioned embodiment, the public network mode is switched to the Internet mode, but it can also be configured to switch from the Internet mode to the public network mode. FIG. 18 shows a processing sequence in this case.

For example, at a time when the user A and the user B are performing the communication in the Internet mode, the user A moves form inside the home to outside the home, and when communications between the mobile phone 100 and the home gateway 200 of the user A become impossible, a notification (such as a message audio, a beep sound, etc.) for indicating that the communication using the Internet mode became unavailable is outputted from the mobile phone 100 of the user A. Receiving this notification, when the user A inputs an instruction to switch to the public network mode, a severance request is sent from the home gateway 200 of the user A to the home gateway 200 of the user B.

The home gateway 200 of the user B receives this request, and sends a severance notification to the mobile phone 100 of the user B. Accordingly, a notification (such as a message audio, a beep sound, etc.) for indicating that the user A's telephone mode switches to the public network mode, is outputted form the mobile phone 100 of the user B. Simultaneously, the home gateway 200 of the user B sends to the home gateway 200 of the user A a severance confirmation notification. Note that, this confirmation notification may be sent in response to the user B inputting a severance acknowledgement into the mobile phone 100 of the user B.

In response to this, the home gateway 200 of the user A severs the communication path in the Internet mode. Simultaneously, the notification indicating that the confirmation notification was received is sent to the mobile phone 100 of the user A. Receiving the notification, the mobile phone 100 of the user A executes the processing to establish the communication path to the mobile phone 100 of the user B in the public network mode. Then, when the communication path is established, the communication using the public network mode is started.

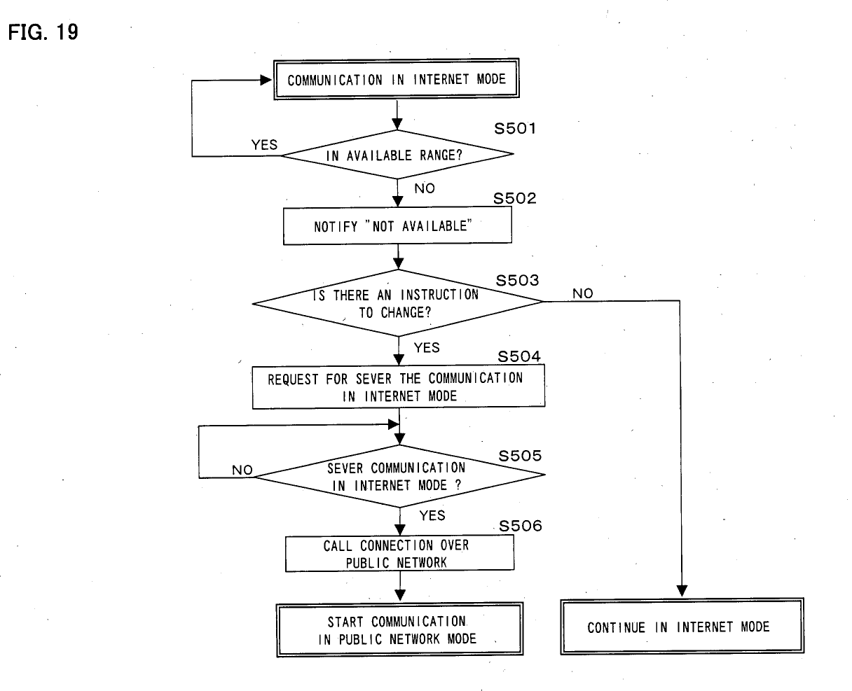

FIG. 19 shows a processing flow upon switching from the communication using the Internet mode to the communication using the public network mode.

In the state of performing the communication in the Internet mode, the main processing unit 105 of the mobile phone 100 references the detection signal from the location detection unit 112, and distinguishes whether or not the mobile phone 100 has reached the boundary vicinity of the range where the Internet communication mode is available. Then, when it distinguishes that the boundary vicinity has been reached, the main processing unit 105 monitors a state of the wireless communications with the home gateway 200 inside the home, and distinguishes whether or not a radio communications level with the home gateway 200 has dropped below a predetermined threshold (S501).

In this way, when it is distinguished that the communication in the Internet mode has become difficult, the main processing unit 105 then sends a notification message indicating that the communication using the Internet mode has become difficult to the audio output unit 102, for example. The message is heard by the user via the audio output unit 102 (S502). Hearing the message, the user inputs the instruction to switch to the public network mode (S503), and the main processing unit 105 sends this instruction to change to its own home gateway 200. Receiving this instruction, the home gateway 200 sends the severance notification of the Internet mode to the opposite party's phone (the mobile phone 100 or the home gateway 200) (S504).

Accordingly, in parallel with the severance processing, the main processing unit 105 of the user's own mobile phone 100 obtains the telephone number of the currently communicating opposite party, from the telephone number book in the memory 105a. Here, for the obtained opposite party's telephone number, if the telephone number corresponding to the the public network (for example, the telephone number of the opposite party's mobile phone) is registered in the telephone number book, then this is used, and if the telephone number corresponding to the public network is not registered, then the telephone number for the Internet telephone is used. Further, in the case where neither telephone number exists in the telephone number book, the telephone number that is used for the current communication is used.

Note that, which telephone number to use may be selected by the user as necessary.

After that, the main processing unit 105 of the user's own mobile phone 100 uses the obtained telephone number, and connects to the base station 300. Accordingly, the call connection to the opposite party's mobile phone 100 in the public network mode is established (S506), and the communication processing in the public network mode is started.

In accordance with this embodiment, when the usage of the Internet mode becomes impossible during the communication, the telephone mode is automatically switched from the Internet mode to the public network mode, thus further improving the user convenience.

Note that, in the processing flow chart in FIG. 19, the communication in the Internet mode is severed once, and the call connection is established in the public network mode. However, as in the processing flow in FIG. 17, before the communication in the Internet mode is severed, the call connection may be established in the public network mode, and after that, the communication in the Internet mode may be severed. However, in this case, in the case when a new call control data is received from another telephone during the communication, the call connection in the public network mode is established only in the case where the function to simultaneously reserve the call connection from the other telephone is set in the opposite party's mobile phone 100. In the case where this function is not provided to the opposite party's mobile phone 100, the call connection is not established.

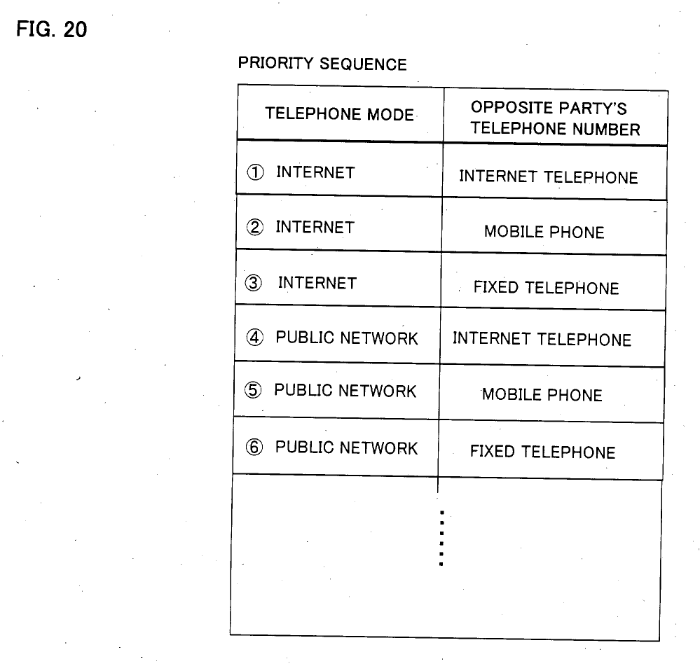

Incidentally, in the above-mentioned processing flow charts in FIGS. 9, 12, and 14, the selection input at S301a is performed by displaying on the monitor the telephone number book stored in the memory 105a. However, the sequence of the telephone numbers displayed may be freely set by the user. For example, a priority sequence table such as shown in FIG. 20 is stored into the memory 105a, and the user can rewrite the priority sequence as needed. In an example in FIG. 20, the Internet mode is prioritized over the public network mode. Further, the telephone number for the Internet telephone is the first priority, the telephone number of the mobile phone using the public network is at the second priority, and telephone number of a fixed telephone using the public network is set at the lowest priority.

The telephone mode and the telephone number displayed on the monitor as the selection candidates at S301a are arranged according to the priority sequence table in FIG. 20. For example, in a case where the telephone number book of the user A is displayed, “Internet mode-Internet telephone number” is displayed at the top, and below that, “Internet mode-mobile phone number”, “Internet mode-Fixed telephone number”. . . “Public network mode-Fixed telephone number” are displayed in sequence.

In this display, the telephone number in the highest priority sequence is highlighted. The user presses a communication start button if this telephone number and telephone mode are acceptable. Accordingly, the telephone number and the telephone mode are selected/set at S301a. In a case where the user selects a telephone number which is not highlighted, the user scrolls the display, and presses the communication start button when the desired number is highlighted.

However, according to the processing flow chart in FIG. 14, in the case where the usage of the Internet mode is judged as unavailable in advance, the Internet mode cannot be selected. Therefore, since items (1) through (3) in the priority sequence in FIG. 20 cannot be selected, the first through the third ones in the set of the telephone modes and telephone numbers which are displayed, are displayed in gray, and are thus removed from the selection range.

Note that, the present invention is not restricted to the above-mentioned embodiments, and it goes without saying that other various modifications are possible.

For example, in accordance with the above-mentioned embodiments, the descriptions have been made using the case of the communication with the opposite party as an example. However, instead of this, a case of sending/receiving email and a case of any data (for example, image data, video data, streaming data) communications with the opposite party are can also be used as examples. Further, the above-mentioned mobile phone 100 is not limited to a PHS (Personal-Handy-Phone) or other such mobile phone device, or any other type provided that it has the mobile phone function. Further, in accordance with the above-mentioned embodiment, the communications between the mobile phone 100 and the home gateway 200 were wireless communications, but a cable communications method may be adopted instead of this.

Moreover, in accordance with the above-mentioned embodiments, the mobile phone performing the wireless communications with the home gateway 200 is only one mobile phone. However, the wireless communications are possible also with a plurality of mobile phones. In this case, when the call control between the user's own home gateway 200 and the opposite party's home gateway 200 is performed, the call control is sent to all the mobile phones 100 which can perform the wireless communications with the opposite party's home gateway 200. The connection is established with the mobile phone 100 which has responded first to the call.

What is claimed is:

1. A mobile terminal device, comprising:
a first communications means for performing communications via a base station;
a second communications means for performing communications via a communications device connected to the Internet;
data processing means for processing an input data to generate send data and for processing receive data to generate an output data; and
setting means for setting whether to establish a data send/receive path between the first communications means and the data processing means or to establish a data send/receive path between the second communications means and the data processing means.

2. A mobile terminal device according to claim 1, further comprising:
distinguishing means for distinguishing a condition of communications with the communications device; and
control means for performing control to establish the data send/receive path, based on a distinction result from the distinguishing means, and a setting set by the setting means.

3. A mobile terminal device according to claim 2, wherein:
when the device has been set by the setting means to establish the data send/receive path between the second communications means and the data processing means,
in a case where the distinguishing means distinguishes that the data send/receive with the communications device is possible, the control means performs control to establish the data send/receive path between the second communications means and the data processing means; and
in a case where the distinguishing means distinguishes that the data send/receive with the communications device is not possible, the control means performs control to establish the data send/receive path between the first communications means and the data processing means.

4. A mobile terminal device according to claim 3, wherein, in a case where the distinguishing means distinguishes that the data send/receive with the communications device is not possible, the control means performs control to prohibit establishing the data send/receive path between the second communications means and the data processing means, and externally outputs an inquiry notification regarding whether or not to establish the data send/receive path between the first communications means and the data processing means.

5. A mobile terminal device, comprising:
a first communications means for performing communications via a base station;
a second communications means for performing communications via a communications device connected to the Internet;
data processing means for processing an input data to generate send data and for processing receive data to generate an output data;
distinguishing means for distinguishing a condition of communications with the communications device; and
control means for performing control to establish a data send/receive path between the first communications means and the data processing means or to establish a data send/receive path between the second communications means and the data processing means,
wherein:
in a case where the distinguishing means distinguishes that the data send/receive with the communications device is possible, the control means performs control to establish the data send/receive path between the second communications means and the data processing means; and
in a case where the distinguishing means distinguishes that the data send/receive with the communications device is not possible, the control means performs control to establish the data send/receive path between the first communications means and the data processing means.

6. A mobile terminal device, comprising:
a first communications means for performing communications via a base station;
a second communications means for performing communications via a communications device connected to the Internet;
data processing means for processing an input data to generate send data and for processing receive data to generate an output data;
distinguishing means for distinguishing a condition of communications with the communications device; and
control means for performing control to establish a data send/receive path between the first communications means and the data processing means or to establish a data send/receive path between the second communications means and the data processing means,
wherein, in a state where the data send/receive path is established between the first communications means and the data processing means, when the distinguishing means distinguishes that the data send/receive with the communications device is possible, the control means performs control to establish the data send/receive path between the second communications means and the data processing means.

7. A mobile terminal device according to claim 6, wherein:
when the distinguishing means distinguishes that data send/receive with the communications device is possible, the control means externally outputs a notification indicating that the data send/receive path can be established between the second communications means and the data processing means; and
after that, in a case where an instruction to switch the data send/receive path is inputted, the control means performs control to establish the data send/receive path between the second communications means and the data processing means.

8. A mobile terminal device, comprising:
a first communications means for performing communications via a base station;
a second communications means for performing communications via a communications device connected to the Internet;
data processing means for processing an input data to generate send data and for processing receive data to generate an output data;
distinguishing means for distinguishing a condition of communications with the communications device; and
control means for performing control to establish a data send/receive path between the first communications means and the data processing means, or to establish a data send/receive path between the second communications means and the data processing means,
wherein in a state where the data send/receive path is established between the second communications means and the data processing means, when the distinguishing means distinguishes that the data send/receive with the communications device is difficult, the control means performs control to establish the data send/receive path between the first communications means and the data processing means.

9. A mobile terminal device according to claim 8, wherein:
when the distinguishing means distinguishes that data send/receive with the communications device is difficult, the control means externally outputs an inquiry notification whether or not to establish the data send/receive path between the first communications means and the data processing means; and
after that, in a case where an instruction to switch the data send/receive path is inputted, the control means performs control to establish the data send/receive path between the first communications means and the data processing means.

10. A mobile terminal device according to any one of claims 1 through 9, further comprising distinction result outputting means for periodically performing the distinction by the distinguishing means and externally outputting each distinction result.

11. A mobile terminal device according to any of claims 1 through 10, further comprising:
storage means for storing addressee information to be used when performing the communications with another terminal device;
communications mode setting means for setting whether to prioritize the communications via the base station or the communications via the communications device; and
display means for displaying as selection candidates the addressee information stored in the storage means, according to the priority sequence set by the communications mode setting means.

12. A mobile terminal device according to claim 11, wherein, in a case where the distinguishing means distinguishes that the data send/receive with the communications device is not possible, the display means is set such that the addressee information corresponding to the communications via the communications device cannot be selected.

13. A communications device existing between a mobile terminal device and the Internet, comprising:
Internet communications means for performing data communications via the Internet;
terminal communications means for performing data communications with the mobile terminal device; and
data processing means for processing data received from the Internet communications means and providing the processed data to the terminal communications means, and also processing data received by the terminal communications means and providing the processed data to the Internet communications means,
wherein data received via the Internet by the Internet communications means is sent to the mobile terminal device by the terminal communications means, and also data received from the mobile terminal device by the terminal communications means is provided to the Internet by the Internet communications means.

14. A communications device according to claim 13, further comprising: distinguishing means for distinguishing a condition of communications with the mobile terminal device,
wherein, in a case where the distinguishing means distinguishes that the communications with the mobile terminal device are impossible, a “communications impossible” response is provided to the Internet by the Internet communications means.

15. A communications device according to claim 13, further comprising:
distinguishing means for distinguishing the condition of communications with the mobile terminal device;
audio input means; and
audio output means,
wherein, in a case where the distinguishing means distinguishes that the communications with the mobile terminal device are impossible, audio data inputted via the Internet communications means is processed by the data processing means and then provided to the audio output means, and also an audio data inputted by the audio input means is processed by the data processing means and then provided to the Internet communications means.

16. A telephone system, comprising:
a communications device connected to the Internet; and
a mobile terminal device capable of performing communications with the communications device, wherein:
the communications device includes:
Internet communications means for performing data communications via the Internet;
terminal communications means for performing data communications with the mobile terminal device; and
data processing means for processing data received from the Internet communications means and providing the processed data to the terminal communications means, and also processing data received by the terminal communications means and providing the processed data to the Internet communications means; and
the mobile terminal device includes:
a first communications means for performing communications with a via station;
a second communications means for performing communications with a communications device connected to the Internet;
data processing means for processing an input data to generate send data and for processing receive data to generate an output data; and
control means for performing control to establish data send/receive path between the first communications means and the data processing means or to establish data send/receive path between the second communications and the data processing means.

17. A telephone system according to claim 16, wherein the mobile terminal device includes:
distinguishing means for distinguishing the condition of the communications with the communications device; and
request sending means for sending a request to the communications device to perform the data communications over the Internet in a case where the distinguishing means distinguishes that the data send/receive with the communications device is possible,
wherein the communications device includes control means for performing the data communications over the Internet via the Internet communications means in a case where a sending request is received from the request sending means.

18. A telephone system according to claim 17, wherein, in a state where the data send/receive path has been established between the first communications device and the data processing means, when the distinguishing means distinguishes that the data send/receive with the communications device are possible, the mobile terminal device sends a request to the communications device to perform the data communications via the Internet by means of the request sending means, and
performs control by means of the control means to establish the data send/receive path between the second communications means and the data processing means.

19. A telephone system according to claim 17, wherein, in a state where the data send/receive path has been established between the second communications device and the data processing means, when the distinguishing means distinguishes that the data send/receive with the communications device are difficult, the mobile terminal device sends a request to the communications device to end the data communications via the Internet; and
performs control by means of the control means to establish the data send/receive path between the first communications means and the data processing means.

20. A communications control method for performing communications via a base station or the Internet, comprising:
a first processing for distinguishing a condition of communications with a communications device connected to the Internet; and
a second processing for controlling a selection of a communications mode in response to a distinction result from the first processing,
wherein, in response to input of an instruction to select the communications via the Internet the first processing distinguishes the condition of communications with the communications device connected to the Internet, and in a case where a result therefrom indicates that data send/receive with the communications device is possible, the communications via the Internet is selected, and in a case where data send/receive with the communications device is not possible, processing for selecting the communications via the base station is executed.

21. A communications control method according to claim 20, wherein, in the case where the first processing distinguishes that the data send/receive with the communications device is not possible, the communications via the Internet are prohibited and a notification inquiring whether or not to perform the communications via the base station is externally outputted.

22. A communications control method for performing communications via a base station or the Internet, comprising:
a first processing for distinguishing a condition of communications with a communications device connected to the Internet; and
a second processing for controlling a selection of a communications mode in response to a distinction result from the first processing,
wherein the first processing distinguishes the condition of communications with the communications device connected to the Internet, and in a case where a result therefrom indicates that data send/receive with the communications device is possible, the communication via the Internet is selected, and in a case where data send/receive with the communications device is not possible, the communication via the base station is selected.

23. A communications control method for performing communications via a base station or the Internet, comprising:
a first processing for distinguishing a condition of communications with a communications device connected to the Internet; and
a second processing for controlling a selection of a communications mode in response to a distinction result from the first processing,
wherein, in a state where the communications via the base station is selected, when the first processing distinguishes that the data send/receive with the communications device is possible, processing for switching to the communications via the Internet is executed.

24. A communications control method according to claim 23, wherein:
in a state where the communication via the base station is selected, when the first processing distinguishes that the data send/receive with the communications device is possible, a notification indicating that the communications via the Internet are possible is externally outputted; and
after that, in a case where an instruction to select the communications via the Internet is inputted, the processing for switching to the communications via the Internet is executed.

25. A communications control method for performing communications via a base station or the Internet, comprising:
a first processing for distinguishing a condition of communications with a communications device connected to the Internet; and
a second processing for controlling a selection of a communications mode in response to a distinction result from the first processing,
wherein in a state where the communications via the Internet is selected, when the first processing distinguishes that the data send/receive via the communications device is difficult, processing for switching to the communications via the base station is executed.

26. A communications control method according to claim 25, wherein:
in a state where the communication via the Internet is selected, when the first processing distinguishes that the data send/receive with the communications device is difficult, a notification indicating that the communication via the base station is possible is externally outputted; and
after that, in a case where an instruction to select the communications via the base station is inputted, processing for switching to the communications via the base station is executed.
